(19) United States
(12) Patent Application Publication
(10) Pub. No.: US 2013/0000493 A1
(43) Pub. Date: Jan. 3, 2013

(54) AUTOMATIC BREAD MACHINE

(76) Inventors: Takashi Watanabe, Tottori-shi (JP); Yasuyuki Ito, Tottori-shi (JP); Hidefumi Nomura, Tottori-shi (JP); Yasushi Sone, Tottori-shi (JP); Syuji Fukuda, Tottori-shi (JP); Yoshinari Shirai, Tottori-shi (JP)

(21) Appl. No.: 13/583,608

(22) PCT Filed: May 17, 2011
(86) PCT No.: PCT/JP2011/061273

§ 371 Date: Sep. 7, 2012

(30) Foreign Application Priority Data
May 18, 2010 (JP) 2010-114421
Jun. 15, 2010 (JP) 2010-136052
Oct. 12, 2010 (JP) 2010-229584
Oct. 29, 2010 (JP) 2010-243712

(51) Int. Cl. A47J 37/01

(52) U.S. Cl. 99/348; 99/426

(57) ABSTRACT

The disclosed automatic bread machine (1) is provided with a first bread receptacle (80) capable of breadmaking with a cereal grain as a starting material, a second bread receptacle (140) capable of breadmaking with a cereal grain as a starting material, and a housing unit (30) which, during breadmaking, selectively houses the first bread receptacle (80) or the second bread receptacle (140), and which, during storage, is capable of housing the first bread receptacle (80) and the second bread receptacle (140) in a state in which one of the bread receptacles is stored inside of the other.

### TECHNICAL FIELD

The present invention is related to an automatic bread machine for use mainly in general households.

### BACKGROUND ART

Commercially available home-use automatic bread machines are typically configured such that bread is baked by using, as a baking pan, a bread container as it is in which bread ingredients are placed (see, for example, Patent Literature 1). In such an automatic bread machine, a bread container in which bread ingredients are placed is set in a baking chamber first. Then, the bread ingredients placed in the bread container are mixed together and kneaded into dough by a mixing/kneading blade provided in the bread container (mixing/kneading step). The mixing/kneading step is followed by a fermentation step in which the kneaded dough is fermented, and then, the fermented dough in the bread container is baked into bread by using the bread container as a baking pan (baking step).

Some conventional home-use automatic bread machines are provided with a special ingredient dispenser so that bread containing special ingredients such as raisin, nuts, and cheese can be baked (see, for example, Patent Literatures 2 and 3). In any of such automatic bread machines, special ingredients placed in the special ingredient dispenser are automatically supplied into the bread container in the mixing/kneading step by, for example, programmed control.

To make bread by using an automatic bread machine, it has been necessary to use, as a bread ingredient, flour of cereal grains such as wheat or rice (wheat flour, rice flour, or the like), or ready-mixed flour produced by mixing such flour and various auxiliary ingredients together. However, in typical households, cereals are sometimes stored in the form of grains such as rice grains, not in the form of flour. Thus, it would be very convenient to have an automatic bread machine capable of making bread directly from cereal grains. In view of the foregoing, the applicants have developed a method of making bread from cereal grains as a starting ingredient (see Patent Literature 4).

With this method of making bread, cereal grains and a liquid are first mixed together, and a grinding blade is made to rotate in the mixture to grind the cereal grains (grinding step). Then, pasty bread material obtained through the grinding step and containing the ground cereal flour is then kneaded into bread dough by using a mixing/kneading blade (mixing/kneading step). Thereafter, a fermentation step is carried out to ferment the kneaded bread dough, and then a baking step is carried out to bake the resulting bread dough into bread.

### CITATION LIST

### Patent Literature

Patent Literature 1: JP-A-2000-116526
Patent Literature 2: Japanese Patent No. 3191645
Patent Literature 3: JP-A-2006-255071
Patent Literature 4: JP-A-2010-35476

### SUMMARY OF INVENTION

### Technical Problem

The applicants have been working on development of automatic bread machines provided with a new mechanism that makes it possible to practice a method of making bread by using cereal grains as a starting ingredient. Among such automatic bread machines, the applicants have been considering developing one that is also capable of easily making bread in a conventional method by using commercially available wheat flour or rice flour.

The applicants have also been considering, as an example of the configuration of the automatic bread machine provided with the new mechanism, for example, one that is capable of performing the above-described steps from the grinding step to the baking step in a bread container placed in a baking chamber provided inside a main body of the bread machine.

More specifically, the applicants have been considering an automatic bread machine configured such that a grinding function and a mixing/kneading function are exerted as necessary by rotation of a single rotation shaft (blade rotation shaft) that is disposed at a bottom portion of the bread container. This configuration requires a coupling for transmitting the rotation of a motor (which is provided inside the main body of the bread machine) to the blade rotation shaft when the bread container is placed in the baking chamber. The coupling required here can be composed of, for example, a main body-side connection portion which is provided at an upper end portion of a drive shaft (a rotation shaft arranged inside the main body to be rotated when a motor inside the main body is driven) and a container-side connection portion which is disposed at a lower end of the blade rotation shaft.

However, an automatic bread machine adopting such a coupling suffers from the following problem. That is, in the grinding step where cereal grains are ground and the mixing/kneading step where bread dough is kneaded, the bread container placed in the baking chamber also tends to receive force. Such force may cause the bread container to float up from its predetermined setting position, which results in disadvantageously unstable transmission of force via the coupling.

This can be coped with, with reference to a conventional bread machine (see, for example, Patent Literature 4), by a configuration where, when the bread container is placed in the baking chamber, the bread container forms a bayonet coupling with the main body so that the bread container does not move (float up) while a bread-making process is being performed. With this configuration, for the purpose of preventing the bread container from being disconnected from the main body by the rotation of the blade rotation shaft, a direction of twisting (for achieving the bayonet coupling) of the bread container when it is placed in the baking chamber is typically conformed to a direction in which the blade rotation shaft rotates.

However, among configurations where the grinding function and the mixing/kneading function are exerted as necessary by using a single blade rotation shaft, the applicants are considering adopting one where the blade rotation shaft rotates in opposite directions for the grinding function and the mixing/kneading function. With such a configuration, even if the above-described bayonet coupling is adopted, in either the grinding or the mixing/kneading step, the bread container moves (floats up) to disadvantageously destabilize transmission of force via the coupling.

Moreover, in automatic bread machines configured such that a bread container is set in a baking chamber and then bread-making steps are carried out, it is often the case that a pointing direction (setting orientation) of the bread container when it is placed (set) in the baking chamber is determined. Thus, easy setting of the bread container according to the setting orientation will desirably make the automatic bread machines user-friendly. This improvement should be made not only in an automatic bread machine capable of baking bread from cereal grains as a starting ingredient but also in an automatic bread machine that bakes bread from cereal flour (such as wheat flour and rice flour) as a starting ingredient.

The present invention has been made in view of the foregoing, and an object of the present invention is to provide an automatic bread machine where an appropriate bread container is selected from two types of bread containers, namely, one for making bread from cereal grains as a starting ingredient and one for making bread from commercially available cereal flour as a starting ingredient, as necessary, and where the two types of bread containers are able to be compactly stored.

Furthermore, another object of the present invention is to provide an automatic bread machine that includes a convenient mechanism that makes it possible to make bread from cereal grains, and a bread container of which is easily settable to its setting position in a main body. Moreover, another object of the present invention is to provide an automatic bread machine that includes a convenient mechanism which makes it possible to make bread from cereal grains, and whose bread container is easily settable to its setting position in a main body and is also difficult to be moved in the main body while bread-making steps are being carried out once the bread container is placed inside the main body.

### Solution to Problem

To achieve the above objects, according to an aspect of the present invention, an automatic bread machine includes: a first bread container which allows breadmaking by using cereal grains as a starting ingredient; a second bread container which allows breadmaking by using cereal flour as a starting ingredient; and an accommodation area in which one of the first bread container and the second bread container is selectively placed for breadmaking, and which accommodates both of the first bread container and the second bread container for storage purpose in a state in which one of the first bread container and the second bread container is placed inside another.

According to an embodiment of the present invention, in the automatic bread machine configured as described above, preferably, when one of the first bread container and the second bread container is stored inside another, a first cushioning member is disposed on an internal bottom surface of an outside bread container to receive an external bottom surface of an inside bread container, and a second cushioning member is disposed along an internal circumferential surface of the outside container to cover an external circumferential surface of the inside bread container.

According to an embodiment of the present invention, in the automatic bread machine configured as described above, preferably, the outside bread container is the first bread container which has a bottom portion with a recess formed therein, and when the inside container is stored in the outside container, the first cushioning member is placed in the recess.

According to an embodiment of the present invention, in the automatic bread machine configured as described above, preferably, the first cushioning member is made of foamed polystyrene and the second cushioning member is made of corrugated cardboard.

Adoption of the above-described configurations allows a user to selectively use either one of the first bread container which allows the user to make bread by using cereal grains as a starting ingredient and the second bread container which allows the user to make bread by using cereal flour as a starting ingredient, according to the stock status of cereal grains and cereal flour or according to whether the user feels like eating bread made from cereal grains or cereal flour as a starting ingredient. When the user puts away the automatic bread machine after making bread, both of the bread containers are able to be placed in the baking chamber with one of the first and second bread containers set inside the other, and thus, the provision of the two kinds of bread containers does not hamper easy storage of the automatic bread machine.

According to an embodiment of the present invention, in the automatic bread machine configured as described above, preferably, an external side surface of the first bread container is provided with a bread container-side guide portion, and an internal side surface of the accommodation area is provided with a main body-side guide portion which engage with the bread container-side guide portion in the vicinity of an upper end portion of the accommodation area to guide the first bread container to a setting position thereof in the accommodation area

With the present configuration, when the first bread container is placed in the setting position in the accommodation area, it reaches the setting position by being guided by the guide portion (two guide portions, namely the bread container-side guide portion and the main body-side guide portion). This makes it easy to set the first bread container in the accommodation area. When the first bread container is received in the baking chamber, at a time point when the bread container-side guide portion is in the vicinity of the upper end portion of the accommodation area, the main body-side guide portion engages with the bread container-side guide portion. This allows the user to easily achieve engagement between the two guide portions by checking visually. Thus, with the present configuration, the user is able to place the first bread container easily in the setting position in the accommodation area.

According to an embodiment of the present invention, in the automatic bread machine configured as described above, preferably, a pedestal is provided on an external surface side of a bottom portion of the first bread container; a bread container support portion which receives the pedestal is provided at a bottom portion of the accommodation area; and the main body-side guide portion is provided in such a manner that the pedestal has not reached the bread container support portion yet at a time when the bread container-side guide portion and the main body-side guide portion start engaging with each other. With the present configuration, it is possible to place the first bread container in the accommodation area by appropriately adjusting the positional relationship between the pedestal and the bread container support portion by using the main body-side guide portion and the bread container-side guide portion. That is, it is possible to avoid a case in which the pedestal is caught by something inside the accommodation area and thus the first bread container is stuck on its way to the setting position in the accommodation area. This allows the user to easily set the first bread container in the accommodation area.

According to an embodiment of the present invention, in the automatic bread machine configured as described above, preferably, in a state in which the first bread container is disposed in the setting position, the bread container-side guide portion and the main body-side guide portion cooperate with each other to exert a function of fastening the first bread container. With the present configuration, it is possible to prevent the first bread container from moving around inside the accommodation area during a bread-making process. Thus, according to the present configuration, it is possible to make bread in a stable manner.

According to an embodiment of the present invention, preferably, the automatic bread machine configured as described above further includes: a rotation shaft which is provided at a bottom portion of the first bread container; a grinding blade and a mixing/kneading blade which are rotatable by rotation of the rotation shaft; a motor which is provided inside a main body which has the accommodation area; and a coupling which transmits rotation force of the motor to the rotation shaft of the first bread container placed in the accommodation area. Here, the grinding blade exerts a grinding function when the rotation shaft is made to rotate in one direction by the motor, and the mixing/kneading blade exerts a mixing/kneading function when the rotation shaft is made to rotate in a direction reverse to the one direction. With the present configuration, it is easy to achieve an automatic bread machine capable of making bread by using cereal grains as a starting ingredient. Furthermore, since the switching between the grinding function and the mixing/kneading function of the automatic bread machine can be carried out simply by switching the rotation direction of the rotation shaft, the control operation performed in the automatic bread machine is not complicated. Moreover, since the fastening of the first bread container is able to be achieved by using the guide portions, although the rotation direction of the rotation shaft is switchable between the two directions, it is possible to prevent disadvantages that would be experienced with bayonet coupling.

According to an embodiment of the present invention, the automatic bread machine configured as described above may be such that a brim portion is provided along an edge of an opening of the first bread container, a carrying handle is attached to the brim portion in such a manner that the carrying handle is able to be raised/laid down freely, and in a state in which the carrying handle is laid down, a portion of the carrying handle is in contact with a projecting portion of a fastening member projecting from the brim portion, the fastening member being provided for fastening the bread container-side guide portion. According to the present configuration, in an operation of laying down the carrying handle from its standing state, it is possible to prevent the carrying handle from coming in contact with the main body of the first bread container when the carrying handle comes down. That is, according to the present configuration, it is possible to reduce the risk of the first bread container being damaged.

According to an embodiment of the present invention, the automatic bread machine configured as described above may be such that the bread container-side guide portion has an engagement groove which extends in a direction in which the first bread container is moved to be received in the accommodation area, and the main body-side guide portion has an engagement projection portion which projects from an internal side surface of the accommodation area and engages with the engagement groove. According to the present configuration, it is easy to obtain a configuration which enables the guide portions to exert two functions of guiding and fastening the first bread container.

According to an embodiment of the present invention, the automatic bread machine configured as described above may be such that the main body-side guide portion has a plate-shaped fastened portion which is attached to the internal side surface of the accommodation area and a projecting-plate portion which is bent over the fastened portion, the projecting-plate portion being the engagement projection portion. And, according to an embodiment of the present invention, in this configuration, the projecting-plate portion may have a bent portion at which a slope angle of the projecting-plate portion is increased with respect to the fastened portion. More specifically, it is preferable that the projecting-plate portion be bent such that the slope angle of the projecting-plate portion with respect to the fastened portion is small at a part of the projecting-plate portion on an upper side in the direction in which the first bread container is moved to be received in the accommodation area and the slope angle is large at a part of the projecting-plate portion below the small-slope-angle part in the direction. With this configuration, it is possible to smoothly place the first bread container in the accommodation area, and it is also possible to obtain sufficient force for fastening the first bread container when the first bread container reaches its setting position.

According to an embodiment of the present invention, in the automatic bread machine configured as described above, preferably, the engagement groove extends to the vicinity of an upper end portion of the first bread container. According to the present configuration, the engagement groove and the engagement projection portion engage with each other over a wide engagement area, and this allows stable guiding of the first bread container by using the bread container-side guide portion and the main body-side guide portion.

### Advantageous Effects of Invention

According to the present invention, it is possible to provide an automatic bread machine where an appropriate bread container is able to be selected from two kinds of bread containers, namely, one for making bread from cereal grains as a starting ingredient and one for making bread from commercially available cereal flour as a starting ingredient, as necessary, and where the two types of bread containers are able to be compactly stored. Furthermore, according to the present invention, it is possible to provide an automatic bread machine that includes a convenient mechanism which makes it possible to make bread from cereal grains and whose bread container is easily settable to in its setting position in a main body and is also difficult to be moved in the main body while bread-making steps are being performed once the bread container is placed inside the main body.

### BRIEF DESCRIPTION OF DRAWINGS

FIG. 1A A perspective view illustrating an exterior configuration of an automatic bread machine according to an embodiment (hereinafter, present embodiment) of the present invention, a lid of the automatic bread machine being closed;

FIG. 1B A perspective view illustrating an exterior configuration of an automatic bread machine according to the present embodiment, the lid of the automatic bread machine being opened;

FIG. 2 A schematic diagram for describing an internal configuration of a main body of the automatic bread machine according to the present embodiment;

FIG. 3A A diagram for describing a clutch included in a first force transmission portion provided in the automatic bread machine according to the present embodiment, the clutch being in a state of shutting down force transmission;

FIG. 3B A diagram for describing the clutch included in the first force transmission portion provided in the automatic bread machine according to the present embodiment, the clutch being in a state of transmitting force;

FIG. 4 A diagram schematically illustrating a configuration of, and around, a baking chamber in which a bread container is placed inside the automatic bread machine of the present embodiment;

FIG. 5 A schematic plan view illustrating the automatic bread machine (when a lid thereof is open) according to the present embodiment as seen from above;

FIG. 6A A schematic side view illustrating a configuration of a main-body-side guide portion provided in the baking chamber of the automatic bread machine according to the present embodiment;

FIG. 6B A schematic perspective view illustrating the main-body-side guide portion provided in the baking chamber of the automatic bread machine according to the present embodiment as seen from obliquely above;

FIG. 6C A schematic perspective view illustrating the main-body-side guide portion provided in the baking chamber of the automatic bread machine according to the present embodiment as seen from obliquely below;

FIG. 7A A schematic side view illustrating a configuration of the bread container of the automatic bread machine according to the present embodiment;

FIG. 7B A schematic perspective view illustrating the bread container of the automatic bread machine according to the present embodiment as seen from obliquely above;

FIG. 7C A schematic perspective view illustrating the bread container of the automatic bread machine according to the present embodiment as seen from obliquely below;

FIG. 8A A schematic diagram for describing a relationship between the main-body-side guide portion and a bread-container-side guide portion when the bread container is placed in the baking chamber, the diagram illustrating a state before the main-body-side guide portion and the bread-container-side guide portion start to engage with each other;

FIG. 8B A schematic diagram for describing a relationship between the main-body-side guide portion and the bread-container-side guide portion when the bread container is placed in the baking chamber, the diagram illustrating a state in which the main-body-side guide portion and the bread-container-side guide portion engage with each other but the bread container has not reached its setting position in the baking chamber yet;

FIG. 8C A schematic diagram for describing a relationship between the main-body-side guide portion and the bread-container-side guide portion when the bread container is placed in the baking chamber, the diagram illustrating a state in which the main-body-side guide portion and the bread-container-side guide portion engage with each other and the bread container has reached its setting position in the baking chamber;

FIG. 9 A schematic perspective view illustrating a configuration of a blade unit of the automatic bread machine according to the present embodiment;

FIG. 10 A schematic exploded perspective view illustrating the configuration of the blade unit of the automatic bread machine according to the present embodiment;

FIG. 11A A schematic side view illustrating the configuration of the blade unit of the automatic bread machine according to the present embodiment;

FIG. 11B A schematic sectional view taken along line A-A in FIG. 11A;

FIG. 12A A bottom plan view of the blade unit of the automatic bread machine of the present embodiment, a mixing/kneading blade being in a folded position;

FIG. 12B A bottom plan view of the blade unit of the automatic bread machine of the present embodiment, the mixing/kneading blade being in an open position;

FIG. 13A A top plan view of the bread container of the automatic bread machine of the present embodiment, the mixing/kneading blade being in the folded position;

FIG. 13B A top plan view of the bread container of the automatic bread machine of the present embodiment, the mixing/kneading blade being in the open position;

FIG. 14A A schematic perspective view illustrating a configuration of a bread ingredient dispenser of the automatic bread machine according to the present embodiment, illustrating mainly a front side of the bread ingredient dispenser;

FIG. 14B A schematic perspective view illustrating the configuration of the bread ingredient dispenser of the automatic bread machine according to the present embodiment, illustrating mainly a rear side of the bread ingredient dispenser;

FIG. 15 A schematic sectional view illustrating the configuration of the bread ingredient dispenser of the automatic bread machine according to the present embodiment;

FIG. 16 A schematic side view illustrating a state in which a lid of the bread ingredient dispenser of the automatic bread machine according to the present embodiment is open;

FIG. 17 A schematic side view for describing an opening angle of the lid of the bread ingredient dispenser of the automatic bread machine according to the present embodiment;

FIG. 18A A schematic diagram illustrating a configuration of the lid of the automatic bread machine according to the present embodiment to which the bread ingredient dispenser is attached, the diagram being a perspective view of the lid as seen from obliquely below;

FIG. 18B A schematic diagram illustrating the configuration of the lid of the automatic bread machine according to the present embodiment to which the bread ingredient dispenser is attached, the diagram being a plan view of the lid as seen from below;

FIG. 19 A schematic sectional view taken along line B-B in FIG. 18B;

FIG. 20 A schematic plan view illustrating a configuration of the lid of the automatic bread machine according to the present embodiment as seen from a bottom surface side of the lid, the lid being in a state after an internal cover and the bread ingredient dispenser are detached therefrom;

FIG. 21A A schematic plan view for describing a relationship between a frame member and a duct of the automatic bread machine according to the present invention, seen as indicated by arrow Y in FIG. 20;

FIG. 21B A schematic plan view for describing the relationship between the frame member and the duct of the automatic bread machine according to the present invention, seen as indicated by arrow Z in FIG. 21A;

FIG. 22 A block diagram of a configuration of the automatic bread machine according to the present embodiment;

FIG. 23 A time chart for a rice-grain bread-making course performed by the automatic bread machine according to the present embodiment;

FIG. 24A An explanatory diagram similar to FIG. 4, the diagram illustrating a state in which a second bread container is placed inside a first bread container;

FIG. 25 An exploded perspective view illustrating the first bread container, the second bread container, a first cushioning member, and a second cushioning member;

FIG. 26 A schematic diagram for describing a modified example of a main body configuration of the automatic bread machine according to the present embodiment, the diagram being a sectional view of the main body taken along a vertical direction;

FIG. 27 A schematic diagram for describing the modified example of the main body configuration of the automatic bread machine according to the present embodiment, the diagram being a sectional view of the main body taken along a horizontal direction;

FIG. 28A A diagram illustrating the modified example of the bread container of the automatic bread machine according to the present embodiment, the diagram being a schematic perspective view as seen from obliquely above; and

FIG. 28B A diagram illustrating the modified example of the bread container of the automatic bread machine according to the present embodiment, the diagram being a schematic side view illustrating a side of the bread container at which the bread-container-side guide portion is provided.

### DESCRIPTION OF EMBODIMENTS

Hereinafter, an embodiment of an automatic bread machine according to the present invention will be described in detail with reference to the accompanying drawings. It should be noted that time, temperature, and the like specifically dealt with in the present specification are just examples, and they are not meant to limit the scope of the present invention in any manner.

(Configuration of Automatic Bread Machine)

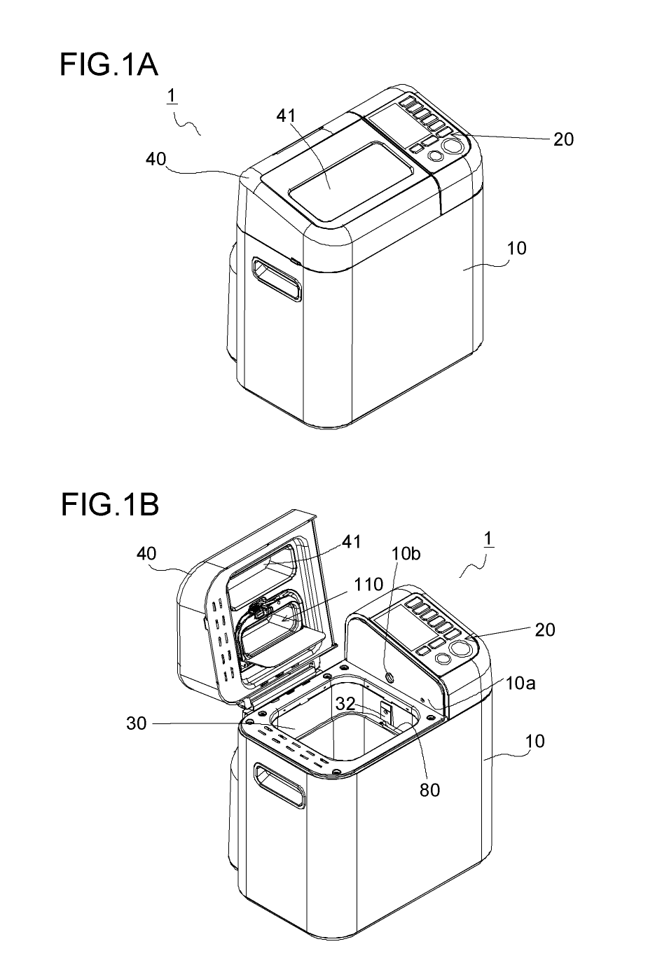

FIGS. 1A and 1B are schematic perspective views illustrating an exterior configuration of an automatic bread machine according to the present embodiment, FIG. 1A illustrating a state where a lid is open, and FIG. 1B illustrating a state where the lid is closed. As shown in FIGS. 1A and 1B, an operation portion 20 is provided at a portion of a top surface of a substantially rectangular-parallelepiped-shaped main body 10 (whose exterior covering is made of a material such as metal or synthetic resin) of an automatic bread machine 1. The operation portion 20 is composed of operation keys and a display portion which displays information of, for example, time, settings that have been set via the operation keys, and errors. The operation keys include keys such as a start key, a cancellation key, a timer key, a preset key, a selection key via which a course for breadmaking is selected (from among a course for making bread by using rice grains as a starting ingredient, a course for making bread by using rice flour as a starting ingredient, a course for making bread by using wheat flour as a starting ingredient, and the like). The display portion includes, for example, a liquid crystal display panel.

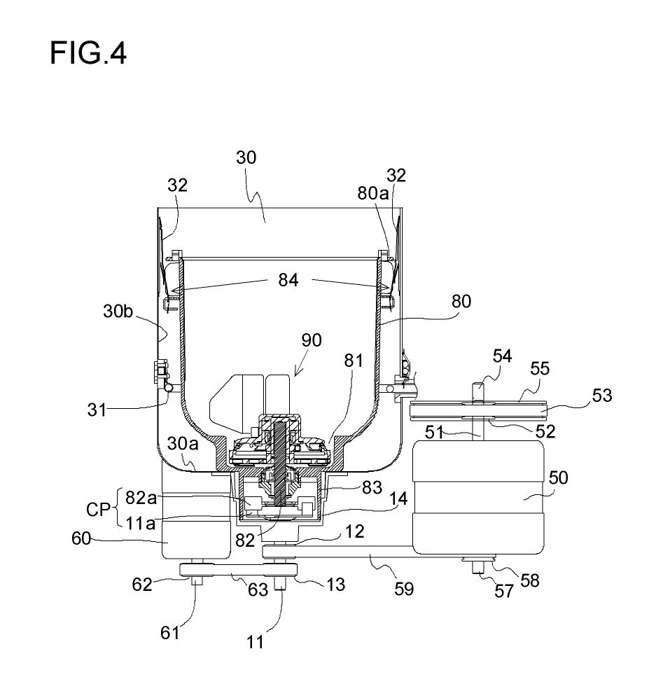

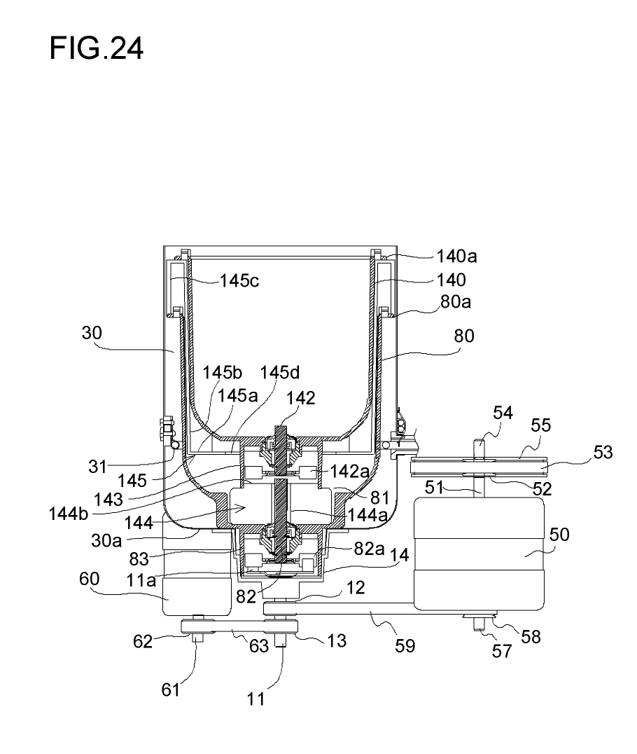

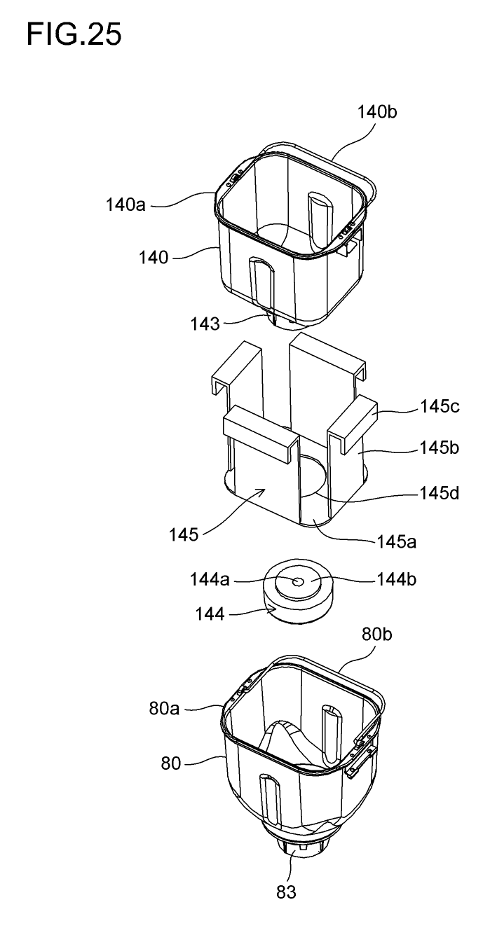

Inside the main body 10, there is provided an accommodation area which accommodates bread containers 80 and 140 as first and second bread containers, respectively, of the present invention (see FIGS. 24 and 25). In the present embodiment, a baking chamber 30 in which the bread containers 80 and 120 are selectively attached serves as the accommodation area. The baking chamber 30 is a box-shaped chamber which is substantially rectangular in plan view, and the baking chamber 30 is composed of a bottom wall 30a and four side walls 30b (also see FIG. 4 which will be referred to later) all of which are made of, for example, a sheet metal. An opening is provided at a top of the baking chamber 30. The opening at the top of the baking chamber 30 is closed with a lid 40 which is provided at a top of the main body 10. The lid 40 is fitted to a rear side of the main body 10 with an unillustrated hinge shaft around which the lid 40 rotates.

In the lid 40, there is provided a viewing window 41 which is made of, for example, heat-resisting glass, and through which inside of the baking chamber 30 can be seen. To the lid 40, a bread ingredient dispenser 110 is detachably attached. The bread ingredient dispenser 110 makes it possible to automatically add some of bread ingredients in the course of a bread-making process. FIG. 1B illustrates a state where the bread ingredient dispenser 110 is attached to the lid 40.

The lid 40 has a slope configuration such that, in a closed state, substantially all of the top surface thereof is increasingly higher from a front surface side toward a rear surface side of the main body 10. This makes it easy, when the lid 40 is in the closed state, for a user to see inside the bread container 80 placed in the baking chamber 30 through the viewing window 10 which is disposed close to the front surface of the main body 10. Furthermore, when the lid 40 is in the closed state, the bread ingredient dispenser 110 which is attached close to the rear surface of the main body 10 is disposed at a portion of the lid 40 where the lid 40 is thick, the bread ingredient dispenser 110 can be configured to be accordingly deep to achieve a large capacity.

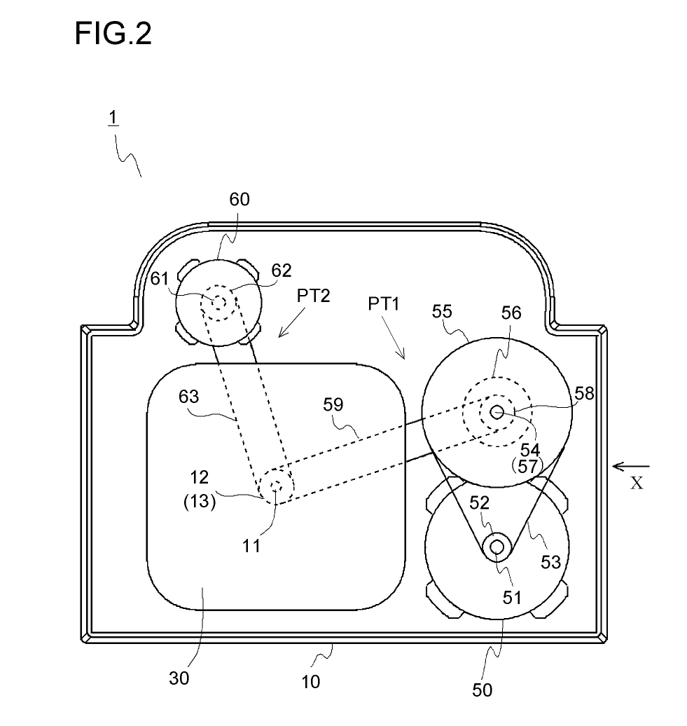

FIG. 2 is a schematic diagram for describing an internal configuration of the main body of the automatic bread machine according to the present embodiment. FIG. 2 illustrates the automatic bread machine 1 as seen from above; the lower side of the figure is the front side of the automatic bread machine 1, while the upper side of the figure is the rear side of the automatic bread machine 1. As illustrated in FIG. 2, the automatic bread machine 1 has a low-speed high-torque mixing/kneading motor 50 which is fixedly disposed on a right side of the baking chamber 30 to be used in the mixing/kneading step, and a high-speed rotation grinding motor 60 which is used in a grinding step and fixedly disposed on a rear side of the baking chamber 30. The mixing/kneading motor 50 and the grinding motor 60 are both vertical-shaft motors.

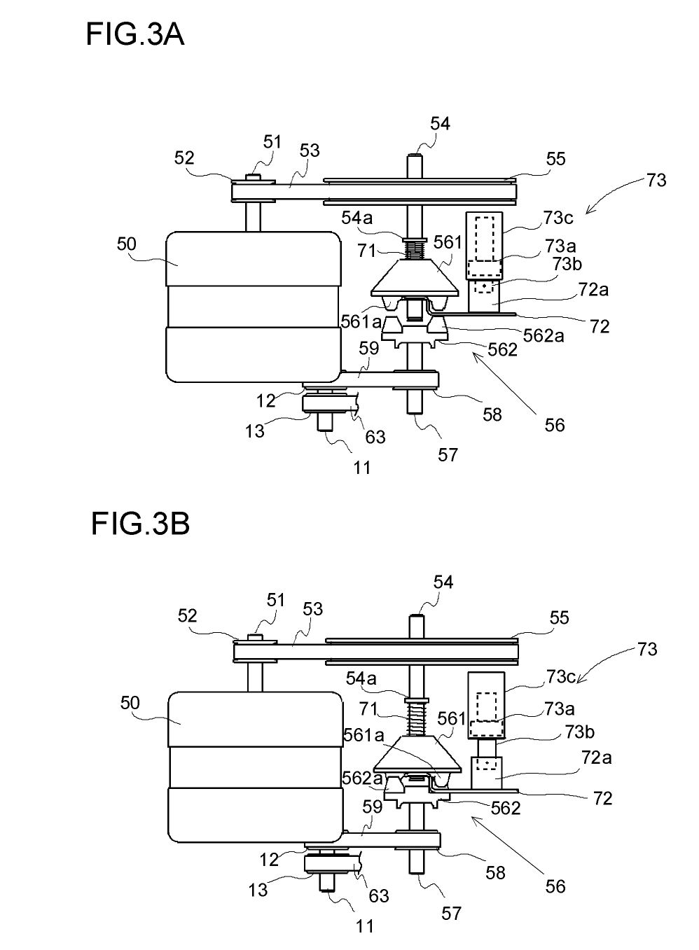

An output shaft 51 projects from a top surface of the mixing/kneading motor 50, and a first pulley 52 is fastened to the output shaft 51. The first pulley 52 is connected, by a first belt 53, to a second pulley 55 which has a larger diameter than the first pulley 52, and which is fastened to an upper portion of the first rotation shaft 54. Under the first rotation shaft 54, there is disposed a second rotation shaft 57 such that centers of rotation of the first and second rotation shafts 54 and 57 are aligned with each other (see FIGS. 3A and 3B). The first and second rotation shafts 54 and 57 are rotatably supported inside the main body 10. Between the first and second rotation shafts 54 and 57, there is provided a clutch 56 which performs force transmission and force interception (see FIGS. 3A and 3B). The configuration of the clutch 56 will be described later.

To a lower portion of the second rotation shaft 57, a third pulley 58 is fastened (see FIGS. 3A and 3B). The third pulley 58 is connected, by a second belt 59, to a first drive-shaft pulley 12 (whose diameter is approximately the same as that of the third pulley 58) which is disposed at a lower portion of the baking chamber 30 and fastened to a drive shaft 11 (see FIGS. 3A and 3B). The mixing/kneading motor 50 itself is a low-speed high-torque motor, and moreover, a rotation speed of the first pulley 52 is reduced by the second pulley 55 (for example, to one-fifth). Thus, if the mixing/kneading motor 50 is driven when the clutch 56 is in a force-transmitting state, the drive shaft 11 rotates at a low speed (for example, at around 180 rpm) and with a high torque.

Incidentally, the force transmission portion composed of the first pulley 52, the first belt 53, the first rotation shaft 54, the second pulley 55, the clutch 56, the second rotation shaft 57, the third pulley 58, the second belt 59, and the first drive-shaft pulley 12 will sometimes be referred to as a first force transmission portion PT1 in the following descriptions.

An output shaft 61 projects from a bottom surface of the grinding motor 60, and a fourth pulley 62 is fastened to the output shaft 61. The fourth pulley 62 is connected, by a third belt 63, to a second drive-shaft pulley 13 which is fastened to the drive shaft 11 (at a position below the first drive-shaft pulley 12; see FIGS. 3A and 3B). The second drive-shaft pulley 13 is substantially equal in diameter to the fourth pulley 62. A motor capable of rotating at a high speed is chosen as the grinding motor 60. The rotation of the fourth pulley 62 is maintained at approximately the same speed in the second drive-shaft pulley 13, and thus the drive shaft 11 rotates at a high speed (for example, at 7000 to 8000 rpm) as the grinding motor 60 rotates at a high speed.

Incidentally, a force transmission portion composed of the fourth pulley 62, the third belt 63, and the second drive-shaft pulley 13 will sometimes be referred to as a second force transmission portion PT2 in the following descriptions. The second force transmission portion PT2 does not include a clutch, and connects the output shaft 61 of the grinding motor 60 and the drive shaft 11 to each other such that force can be transmitted constantly.

FIGS. 3A and 3B are diagrams for describing the clutch included in the first force transmission portion of the automatic bread machine according to the present embodiment. FIGS. 3A and 3B illustrate the automatic bread machine seen as indicated by arrow X in FIG. 2. The clutch 56 includes a first clutch member 561 and a second clutch member 562. When a claw 561a of the first clutch member 561 and a claw 562a of the second clutch member 562 are engaged with each other (the state shown in FIG. 3B), the clutch 56 performs force transmission. When the claws 561a and 562a are not engaged with each other (a state shown in FIG. 3A), the clutch 56 performs force interception. That is, the clutch 56 is a dog clutch.

In the present embodiment, six claws 561a and six claws 562a are provided in the clutch member 561 and in the clutch member 562, respectively, such that the claws are arranged in circumferential directions (of the first clutch member 561 as seen from below, and of the second clutch member 562 as seen from above) to be approximately evenly spaced from each other. A preferable number and a preferable shape may be selected, as necessary, as those of the claws 561a and 562a.

With measures taken against coming-off of the first clutch member 561, the first clutch member 561 is attached to the first rotation shaft 54 to be slidable in an axis direction of the first rotation shaft 54 (up-down direction in FIGS. 3A and 3B) and not to be relatively rotatable with respect to the first rotation shaft 54. A spring 71 is loosely fitted to the first rotation shaft 54 at a position thereof over the first clutch member 561. The spring 71 is disposed between a stopper 54a of the first rotation shaft 54 and the first clutch member 561, to apply a downward force to the first clutch member 561. On the other hand, the second clutch member 562 is fastened to an upper end portion of the second rotation shaft 57.

The clutch 56 is switched between force transmitting and force intercepting states by using an arm 72 which is movable between lower and upper positions. A portion of the arm 72 is located under the first clutch member 561 to be in contact with a circumference of the first clutch member 561.

The arm 72 is driven by using a clutch solenoid 73. The clutch solenoid 73, which includes a permanent magnet 73a, is a so-called self-sustaining solenoid. A plunger 73b of the clutch solenoid 73 is fastened to an attaching portion 72a of the arm 72, the attaching portion 72a being provided for fastening the plunger 73b. With this configuration, the arm 72 moves in conformity with movement of the plunger 73b which moves when voltage is applied thereto.

When the arm 72 moves from its lower position (the state shown in FIG. 3B) to its upper position (the state shown in FIG. 3A), the first clutch member 561 is pushed by the arm 72 to move upward against the downward force applied thereto by the spring 71. When the arm 72 is at its upper position, the first clutch member 561 and the second clutch member 562 do not engage with each other. That is, when the arm 72 is at its upper position, the clutch 56 functions to intercept force.

On the other hand, when the arm 72 moves from its upper position to its lower position, the first clutch member 561 is moved downward by the downward force of the spring 71. When the arm 72 is at its lower position, the first clutch member 561 and the second clutch member 562 engage with each other. That is, when the arm 72 is at its lower position, the clutch 56 functions to transmit force.

When the grinding motor 60 is driven, if the clutch 56 is in the force transmitting state (the state illustrated in FIG. 3B), rotation force which makes the drive shaft rotate at high speed is transmitted to the output shaft 51 of the mixing/kneading motor 50 (see FIG. 2). In this case, assuming that the grinding motor 60 is made to rotate at, for example, 8000 rpm, depending on the radius ratio (for example, 1:5) between the first pulley 52 and the second pulley 55, it is necessary to obtain force capable of making the output shaft 51 of the mixing/kneading motor 50 at, for example, 40000 rpm. As a result, a large burden is imposed on the grinding motor 60, which might cause damage on the grinding motor 60. To prevent this, when the grinding motor 60 is driven, it is necessary to prevent the rotational force that makes the drive shaft 11 rotate at high speed from being transmitted to the output shaft 51 of the mixing/kneading motor 50. For this purpose, as described above, the automatic bread machine 1 is configured to include the clutch 56 which functions to transmit and intercept force in the first force transmission portion PT1.

Incidentally, as already described above, in the automatic bread machine 1, no clutch is provided in the second force transmission portion PT2, and this is for the following reasons. That is, the mixing/kneading motor 50 is driven only to rotate the drive shaft 11 at low speed (for example, at 180 rpm). Thus, even if the configuration is such that the rotational force that rotates the drive shaft 11 is transmitted to the output shaft of the grinding motor 60, no large burden is imposed on the mixing/kneading motor 50. Besides, by choosing to adopt the configuration where no clutch is provided in the second force transmission portion PT2, it is possible to reduce production cost of the automatic bread machine 1. It goes without saying, however, that a configuration may be adopted in which a clutch is provided in the second force transmission portion PT2 as well.

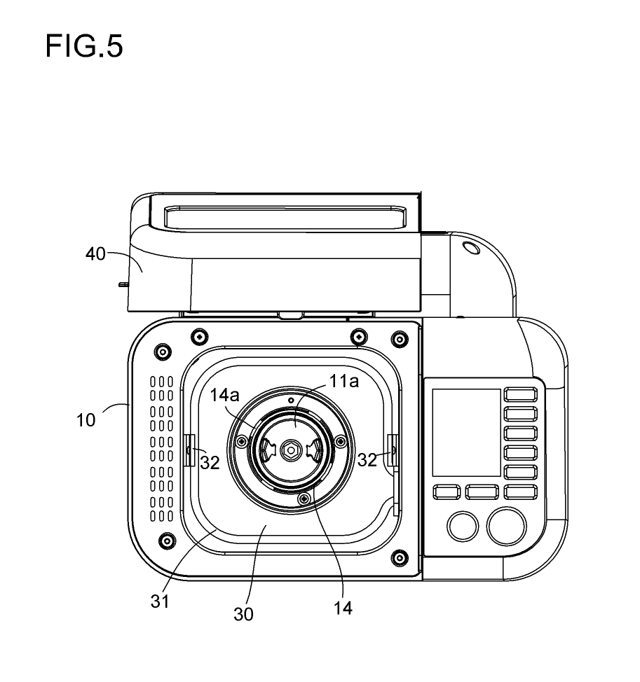

FIG. 4 is a diagram schematically illustrating a configuration of, and around, the baking chamber in which a bread container is placed in the automatic bread machine of the present embodiment. FIG. 4 illustrates the configuration of the automatic bread machine 1 as seen from the front side, with the configuration of the baking chamber 30 and the bread container 80 mostly illustrated as a sectional view. FIG. 5 is a schematic plan view illustrating the automatic bread machine (with the lid open) according to the present embodiment as seen from above. FIG. 5 illustrates a state after the bread container 80 is taken out of the baking chamber 30. Note that the bread container 80, to which bread ingredients are supplied and which is used also as a bread baking pan, is able to be freely placed in, and taken out of, the baking chamber 30.

As shown in FIGS. 4 and 5, inside the baking chamber 30, there are arranged a sheath heater 31 (an example of heating means) so as to surround the bread container 80 placed in the baking chamber 30. By energizing the sheath heater 31, it is possible to apply heat to bread ingredients (including dough) placed in the bread container 80.

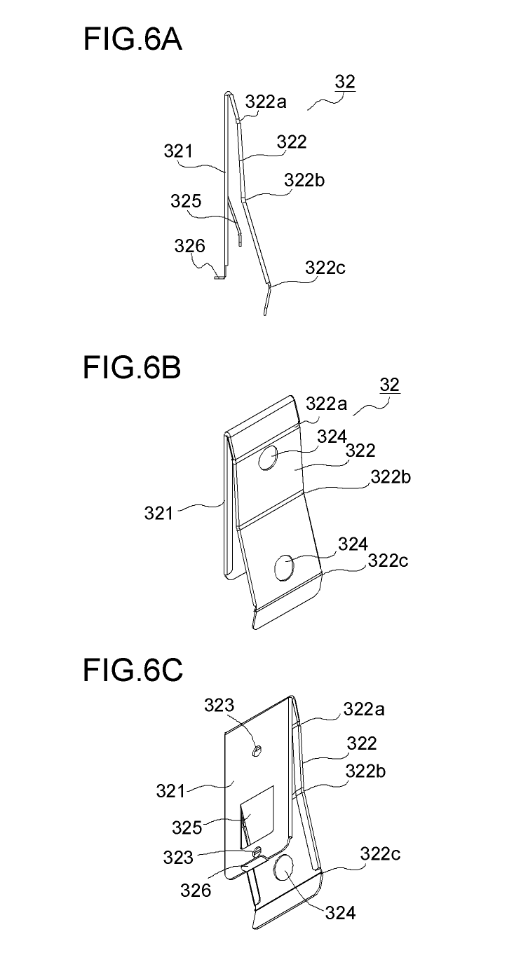

Besides, main body-side guide portions 32 are provided on two opposing side walls 30b (two side walls that face each other in a long side direction) of the baking chamber 30 at positions close to a top edge of the baking chamber 30. These main body-side guide portions 32, in cooperation with bread container-side guide portions 84 (see FIG. 4) which will be described later, not only enable the bread container 80 to be smoothly placed in the baking chamber 30 but also helps fasten the bread container 80 stationary. FIGS. 6A, 6B, and 6C are schematic diagrams illustrating a configuration of the main body-side guide portions of the baking chamber of the automatic bread machine according to the present embodiment; FIG. 6A is a side view, FIG. 6B is a perspective view seen from obliquely above, and FIG. 6C is a perspective view seen from obliquely below.

The main body-side guide portions 32 each include: a plate-shaped fastened portion 321 which is attached to an internal surface of a side wall 30b of the baking chamber 30; and a projecting-plate portion 322 (which corresponds to an engagement projection portion of the present invention) which is bent over the fastened portion 321 such that it projects toward inside of the baking chamber 30. The main body-side guide portions 32 are, for example, each integrally obtained by bending a sheet metal, and exert a function as a flat spring member as well.

In the fastened portion 321, two holes (screw holes 323) are provided for screw fitting at positions in upper and lower portions of the fastened portion 321, and in the present embodiment, the main body-side guide portions 32 are fastened to the side walls 30b by using screws. It should be noted that main body-side guide portions 32 may be fastened to the side walls 30b without using screws, and if screws are not used, the screw holes 323 do not need to be provided. The main body-side guide portions 32 are fastened such that upper ends thereof are located in the vicinity of an upper end portion of the baking chamber 30. A tip end bent portion 326, which is provided at a lower end of the fastened portion 321, is used for positioning when the main body-side guide portions 32 are fitted to the side walls 30b, but the tip end bent portion 326 may be omitted in some cases.

Through holes 324 are provided at positions in upper and lower portions of the projecting-plate portion 322. The through holes 324 are provided so that, when the main body-side guide portions 32 are fastened to the side walls 30b by using screws, the screws can be inserted from inside the baking chamber 30. The through holes 324 may be omitted in some cases.

In the projecting-plate portion 322, there are provided a first bent portion 322a, a second bent portion 322b, and a third bent portion 322c, in this order from the top. The first bent portion 322a reduces a slope angle (projecting amount) of the projecting-plate portion 322 with respect to the fastened portion 321. The second bent portion 322b increases a slope angle (projecting amount) of the projecting-plate portion 322 with respect to the fastened portion 321. As a result, the projecting-plate portion 322 is shaped such that, in side view, a portion thereof above an approximate center thereof does not project very much with respect to the fastened portion 321, and a portion thereof below the approximate center thereof greatly projects with respect to the fastened portion 321. The third bent portion 322c, which is a portion bent in such a direction that makes small a projecting amount of the projecting-plate portion 322 with respect to the fastened portion 321, is provided for enhanced safety and the like.

The fastened portion 321 has an auxiliary projecting plate 325 disposed at a position below and close to a substantial center of the fastened portion 321, the auxiliary projecting plate 325 projecting toward the projecting-plate portion 322. The auxiliary projecting plate 325 is provided for the purpose of reinforcing elasticity of the projecting-plate portion 322, but it is not indispensable.

Back to FIGS. 4 and 5, at a position corresponding to a substantial center of the bottom wall 30a of the baking chamber 30, there is fastened a bread container support 14 (for example, a die-cast aluminum alloy product) which supports the bread container 80 (or the bread container 140). The bread container support 14 is configured to be depressed from the bottom wall 30a of the baking chamber 30, and the depressed shape of the bread container support 14 has a substantially circular shape as seen from above. An internal wall of the bread container support 14 has four engagement grooves 14a which are disposed equally spaced from each other in a circumferential direction thereof. Besides, at a center of the bread container support 14, there is supported the above-described drive shaft 11 to be substantially perpendicular to the bottom wall 30a. To an upper end portion of the drive shaft 11, a main body-side connection portion 11a is fastened.

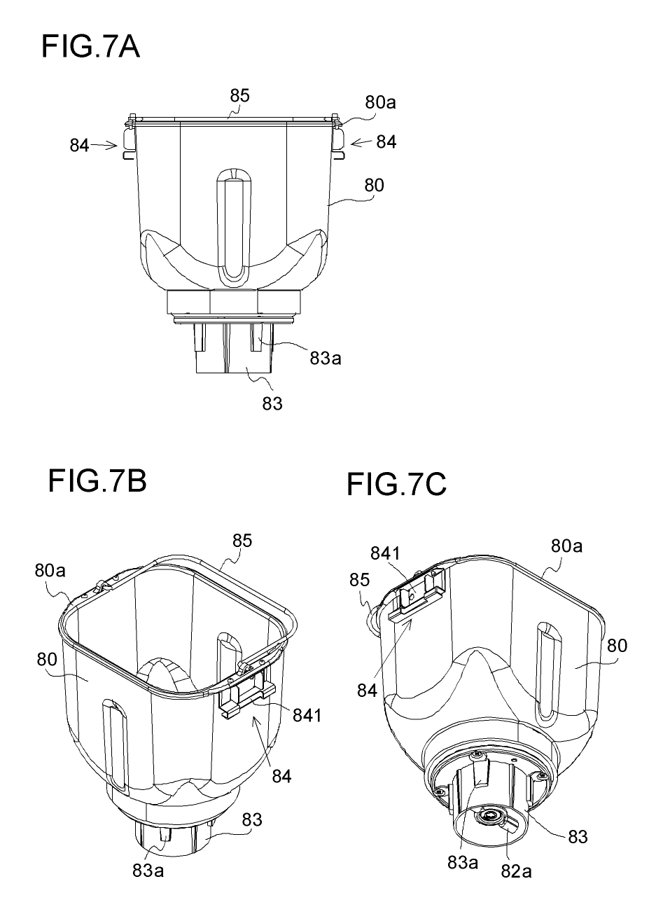

FIGS. 7A, 7B, and 7C are schematic diagrams illustrating a configuration of a bread container that the automatic bread machine of the present embodiment includes; FIG. 7A is a side view, FIG. 7B is a perspective view as seen from obliquely above, and FIG. 7C is a perspective view as seen from obliquely below. A description will be given below of a configuration of the bread container 80, with reference mainly to FIGS. 4, 7A, 7B, and 7C. The bread container 80 is, for example, a die-cast aluminum alloy product (the bread container may also be made of a sheet metal or the like), and has a bucket-like shape. A brim portion 80a is provided along an edge of an opening of the bread container 80 (in other words, “at an upper end portion of the bread container 80, so as to surround the opening”). To the brim portion 80a, there is fitted a carrying handle 85 which is rotatably supported and can be raised or laid down freely. A horizontal sectional shape of the bread container 80 is a shape of a rectangle with four rounded corners. Furthermore, in a bottom portion of the bread container 80, there is provided a recess 81 having a substantially circular plan shape for receiving part of a blade unit 90 which will be described later in detail.

At a center of the bottom portion of the bread container 80, a vertically extending blade rotation shaft 82 (an example of the rotation shaft of the present invention) is rotatably supported with measures taken for sealing. To a lower end (which projects to outside from the bottom portion of the bread container 80) of the blade rotation shaft 82, a container-side connection portion 82a is fastened.

On an external surface side of a bottom portion of the bread container 80, there is provided a cylindrical pedestal 83 so as to surround the blade rotation shaft 82. The bread container 80 is designed to be placed (set in its setting position) inside the baking chamber 30 with the pedestal 83 received in the bread container support 14. The pedestal 83 may be separately formed from the bread container 80, or may be integrally formed with the bread container 80.

An external surface of the pedestal 83 has four engagement projections 83a which are equally spaced from each other in a circumferential direction thereof. The bread container 80 is attached in the baking chamber 30 in the following manner: the position of the bread container 80 is adjusted such that the engagement projections 83a of the pedestal 83 fit into the engagement grooves 14a of the bread container support 14 and is then pushed down to be attached in the baking chamber 30 at its proper position in horizontal direction (a planer direction substantially perpendicular to the blade rotation shaft 82).

A width of each of the engagement projections 83a in the circumferential direction is approximately the same as (slightly smaller than) that of a corresponding one of the engagement grooves 14a. The number and size of the engagement grooves 14a and the engagement projections 83a may be changed as necessary as long as they are able to help positioning of the bread container 80. Furthermore, there may be provided an engagement projection on an internal wall of the bread container support 14 and an engagement groove in the pedestal 83 of the bread container 80.

When the bread container 80 is placed inside the baking chamber 30 with the pedestal 83 of the bread container 80 received in the bread container support 14, the container-side connection portion 82a provided at the lower end of the blade rotation shaft 82 and the main body-side connection portion 11a fastened to the upper end portion of the drive shaft 11 are connected with each other. In this state, the blade rotation shaft 82 receives the rotational force from the drive shaft 11. That is, the main body-side connection portion 11a and the container-side connection portion 82a together form a coupling CP (an example of the coupling of the present invention).

Besides, the bread container-side guide portions 84 are provided on external surfaces of two opposing side walls (two side walls that face each other in a long side direction) of the bread container 80. The bread container-side guide portions 84, in cooperation with the main body-side guide portions 32 (see, for example, FIG. 4), not only helps the bread container 80 to be smoothly placed in the baking chamber 30 but also functions to keep the bread container 80 fastened stationary.

The bread container-side guide portions 84 are, for example, each integrally formed by bending a sheet metal. In the present embodiment, the bread container-side guide portions 84 are fastened to the bread container 80 by using fasteners such as screws and rivets. Needless to say, the bread container-side guide portions 84 may be fastened to the bread container 80 by a different method. The bread container-side guide portions 84 extend in a direction (up-down direction) in which the bread container 80 is moved to be received in the baking chamber 30, and the bread container-side guide portions 84 each include an engagement groove 841 (which is an example of the engagement groove of the present invention) which engages with the projecting-plate portion 322 of the corresponding one of the main body-side guide portions 32.

Although the position of each of the engagement grooves 841 in the up-down direction is not limited to a specific position, the engagement grooves 841 are provided at positions closer to the top than to the bottom of the bread container 80. Also, for the purpose of allowing the engagement grooves 841 to engage with the main body-side guide portions 32 over a wider area, it is preferable that the engagement grooves 841 have a width of a sufficient extent in the up-down direction, and thus, in the present embodiment, the engagement grooves 841 are configured to extend as far as to the vicinity of the top end of the bread container 80. Also, in the present embodiment, bottom surface of the engagement grooves 841 each include a stepped configuration (such that the engagement grooves 841 are each deeper at an upper-portion side than at a lower-portion side), but the bottom surfaces of the engagement grooves 841 do not necessarily need to include such a stepped configuration (for example, the bottom surfaces may be of the same depth as the bottom portion side of each of the bottom surfaces of the engagement grooves 841 of the present embodiment).

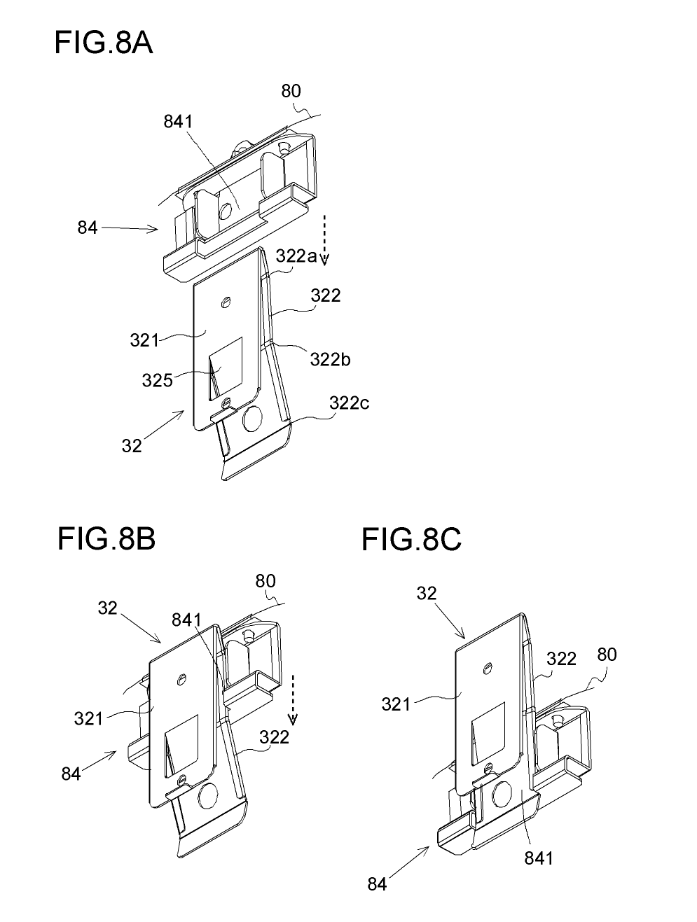

FIGS. 8A, 8B, and 8C are schematic diagrams for describing a relationship between a main body-side guide portion and a bread container-side guide portion in a case in which the bread container is placed in the baking chamber. FIG. 8A illustrates a state before the main body-side guide portion 32 and the bread container-side guide portion 84 start to engage with each other. FIG. 8B illustrates a state in which the main body-side guide portion 32 and the bread container-side guide portion 84 engage with each other but the bread container 80 has not yet reached its setting position in the baking chamber 30. FIG. 8C illustrates a state in which the main body-side guide portion 32 and the bread container-side guide portion 84 engage with each other and the bread container 80 has reached its setting position in the baking chamber 30. Broken-line arrows in FIGS. 8A and 8B each indicate a direction in which the bread container 80 is moved (a direction in which the bread container 80 is put down) to place it in the baking chamber 30.

When the predeterminedly oriented bread container 80 is put down in the direction indicated by the broken-line arrows (assume a shift from the state illustrated in FIG. 8A to the state illustrated in FIG. 8B), the bread container-side guide portion 84 and the main body-side guide portion 32 start to engage with each other. Specifically, at this stage, the projecting-plate portion 322 of the main body-side guide portion 32 is caught in the engagement groove 841 of the bread container-side guide portion 84. As a result, the bread container 80 starts to move by being guided by the main body-side guide portions 32 thereafter. By guiding the bread container 80 in this way, it is possible to securely obtain the engagement between the engagement grooves 14a of the bread container support 14 and the engagement projections 83a provided on the pedestal 83 of the bread container 80.

Note that the main body-side guide portions 32 are provided such that the upper ends thereof are located in the vicinity of the upper end portion of the baking chamber 30. Thus, when the bread container 80 is placed in the baking chamber 30, before the pedestal 83 of the bread container 80 reaches the bread container support 14, the main body-side guide portions 32 start guiding the bread container-side guide portions 84. Furthermore, at a time when the bread container-side guide portions 84 are in the vicinity of the upper end portion of the baking chamber 30, the main body-side guide portions 32 engage with the bread container-side guide portions 84, and thus, a user is able to easily adjust the orientation of the bread container 80, while verifying by visual check, such that the bread container-side guide portions 84 and the main body-side guide portions 32 engage with each other.

When the bread container-side guide portions 84 and the main body-side guide portions 32 start to engage with each other, the projecting-plate portion 322 of each of the main body-side guide portions 32 starts to press the bread container 80. The projecting-plate portion 322, however, is shaped such that, in side view, the portion thereof above the approximate center thereof does not project very much with respect to the fastened portion 321, and thus, at an early stage of the engagement, only a small force is applied to the bread container 80 by the projecting-plate portion 322, so that it is easy to move the bread container 80 downward.

When the bread container 80 is moved further downward while it is being guided by the main body-side guide portion 32 (assume the shift from the state illustrated in FIG. 8B to the state illustrated in FIG. 8C), a portion (a lower portion) of the projecting-plate portion 322 that greatly projects with respect to the fastened portion 321 comes to engage with the engagement groove 841 of the bread container-side guide portion 84. In a state in which the bread container 80 has reached the setting position in the baking chamber 30, the lower portion of the projecting-plate portion 322 is pressed by the bread container-side guide portion 84 to be greatly deformed. As a result, the bread container 80 is pressed strongly by the projecting-plate portion 322 to be unmovably fastened (such that it does not float up) inside the baking chamber 30.

Note that, in the present embodiment, in the state in which the bread container 80 has reached the setting position in the baking chamber 30, the auxiliary projecting plate 325 of the fastened portion 321 is pressed by the projecting-plate portion 322 to be deformed, and thus, the reaction force of the auxiliary projecting plate 325 also functions as a force to press the bread container 80. This makes it possible to fasten the bread container 80 more securely.

The bread container 140 has almost the same configuration as the bread container 80 (see FIGS. 24 and 25). That is, the bread container 140 is, for example, a die-cast aluminum alloy product (the bread container may also be made of a sheet metal or the like), has a bucket-like shape, and has a carrying handle 140b (see FIG. 25) fitted to a brim portion 140a provided along an edge of an opening thereof. A horizontal sectional shape of the bread container 140 is a shape of a rectangle with four rounded corners. In contrast to the bread container 80, however, no recess corresponding to the recess 81 of the bread container 80 is provided in a bottom portion of the bread container 140.

At a center of the bottom portion of the bread container 140, a vertically extending blade rotation shaft 142 (an example of the rotation shaft of the present invention) is rotatably supported with measures taken for sealing. To a lower end (which projects to outside from the bottom portion of the bread container 140) of the blade rotation shaft 142, a container-side connection portion 142a is fastened.

On an external surface side of a bottom portion of the bread container 140, there is provided a cylindrical pedestal 143 so as to surround the blade rotation shaft 142. The bread container 140 is designed to be placed (set in its setting position) inside the baking chamber 30 with the pedestal 143 received in the bread container support 14. The pedestal 143 may be formed separately from the bread container 140, or may be integrally formed with the bread container 140.

When the bread container 140 is placed inside the baking chamber 30 with the pedestal 143 of the bread container 140 received in the bread container support 14, the container-side connection portion 142a provided at the lower end of the blade rotation shaft 142 and the main body-side connection portion 11a fastened to the upper end portion of the drive shaft 11 are connected with each other. In this state, the blade rotation shaft 142 receives the rotational force from the drive shaft 11. That is, the main body-side connection portion 11a and the container-side connection portion 142a together form a coupling.

In the bread container 140, the container-side connection portion 142a and the pedestal 143 are sized and shaped the same as the container-side connection portion 82a and the pedestal 83, respectively, of the bread container 80, but a portion thereof serving as a container main body, which is above the container-side connection portion 142a and the pedestal 143, is made a size smaller than the corresponding portion of the bread container 80. With this configuration, as will be described later, the bread container 140 is able to be stored inside the bread container 80.

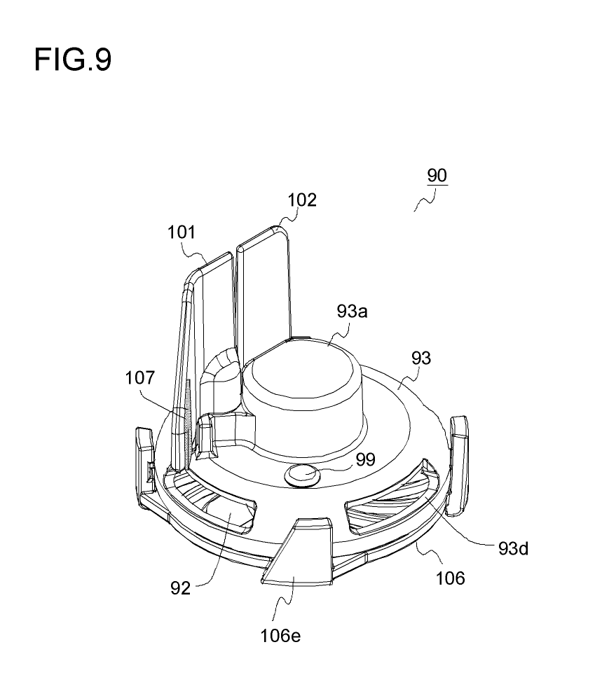

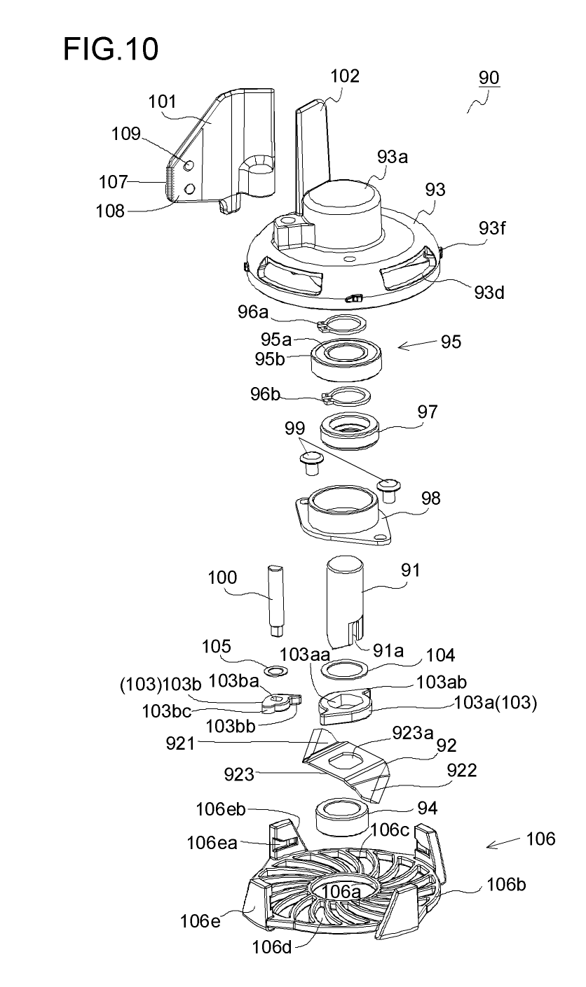

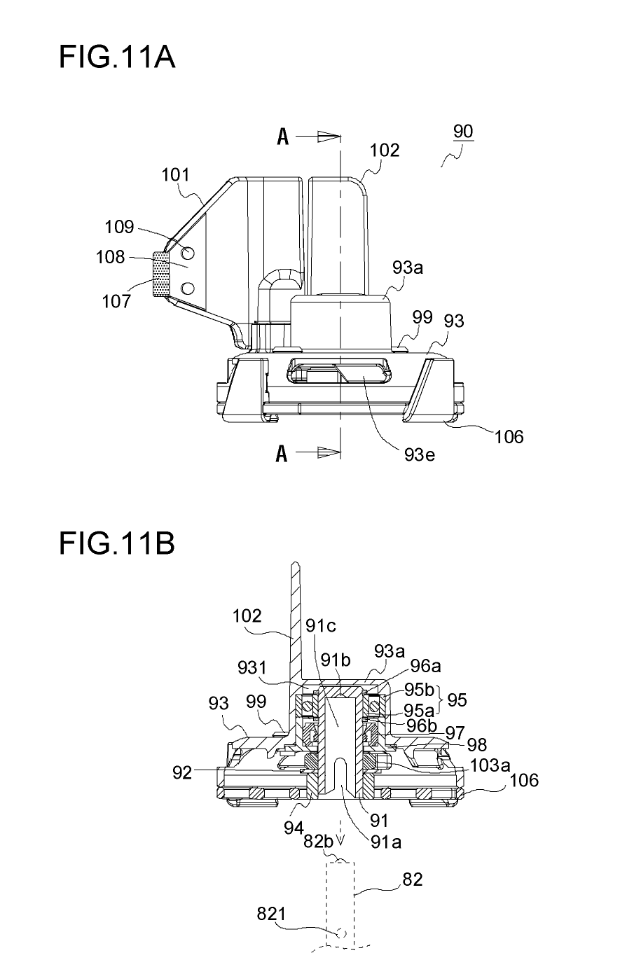

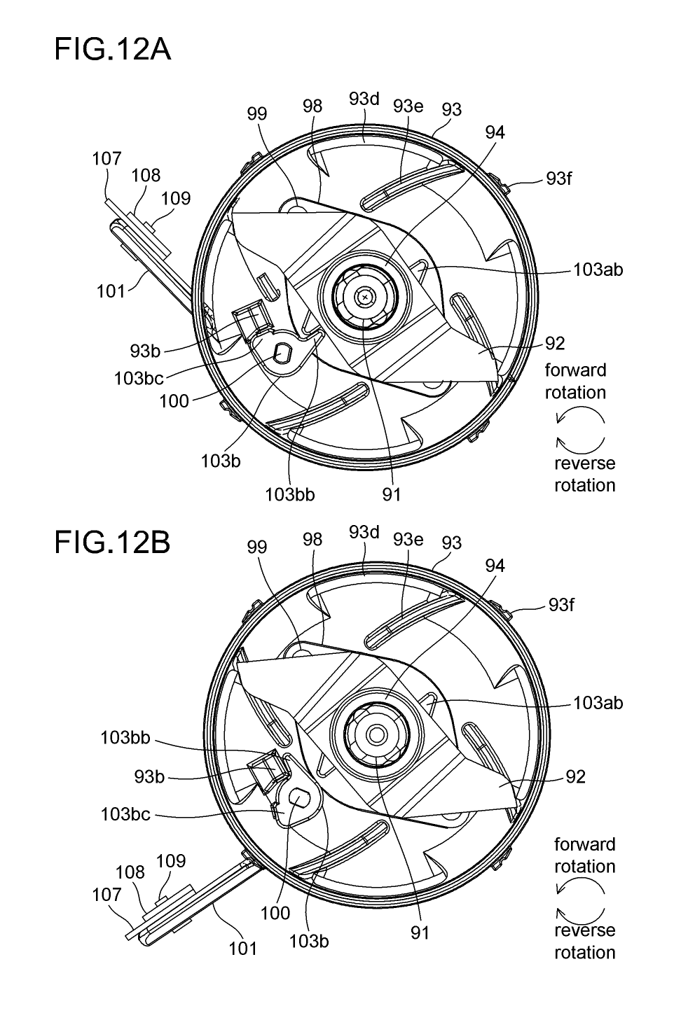

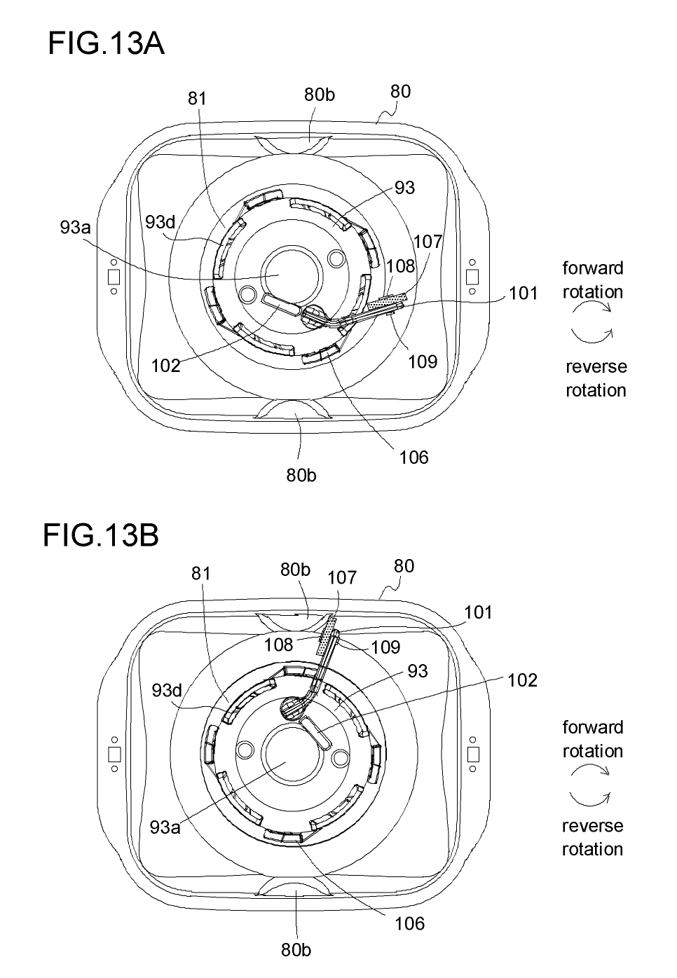

Back to the bread container 80, to a projecting portion of the blade rotation shaft 82 that projects to the inside of the bread container 80, the blade unit 90 is detachably attached. A description will be given of a configuration of the blade unit 90, with reference to FIG. 9, FIG. 10, FIG. 11A, FIG. 11B, FIG. 12A, FIG. 12B, FIG. 13A, and FIG. 13B.

The blade unit 90 includes a unit shaft 91, a grinding blade 92 which is attached to the unit shaft 91 not to be relatively rotatable with respect to the unit shaft 91, a dome-shaped cover 93 which is attached to the unit shaft 91 to be relatively rotatable with respect to the unit shaft 91 and to cover the grinding blade 92 from above, the dome-shaped cover 93 having a substantially circular shape in plan view, a mixing/kneading blade 101 which is attached to the dome-shaped cover 93 to be relatively rotatable with respect to the dome-shaped cover 93, and a guard 106 which is attached to the dome-shaped cover 93 to cover the grinding blade 92 from below. FIGS. 12A and 12B each illustrate a state in which the guard 106 is detached.

In a state in which the blade unit 90 is attached to the blade rotation shaft 82, the grinding blade 92 is located at a position slightly above a bottom surface of the recess 81 of the bread container 80. The grinding blade 92 and the dome-shaped cover 93 are mostly disposed within the recess 81 (see FIG. 4).

The unit shaft 91, which is a substantially cylindrical member made of, for example, a metal such as a stainless steel sheet, has an opening provided at one end (a lower end) thereof and has a hollow inside. That is, the unit shaft 91 has an insertion hole 91c such that the blade rotation shaft 82 is able to be inserted therein from the lower end thereof (see, for example, FIG. 11B).

In a lower portion (an open-side portion) of a side wall of the unit shaft 91, a pair of cuts 91a are symmetrically arranged with respect to a rotational center of the unit shaft 91 (see FIG. 10, where just one of the pair of the cuts 91a is illustrated). The cuts 91a have a vertically-long rectangular side surface and a rounded upper end. The cuts 91a are provided to engage with a pin 821 (see FIG. 11) which horizontally penetrates the blade rotation shaft 82. By the pin 821 of the blade rotation shaft 82 engaging in the cuts 91a, the unit shaft 91 is attached to the blade rotation shaft 82 to be relatively non-rotatable with respect to the blade rotation shaft 82.

As illustrated in FIG. 11B, a recess 91b is provided in a middle portion of an upper surface inside the unit shaft 91 so as to engage with a projecting portion 82b which is provided in a middle portion of an upper end surface (which is substantially circular) of the blade rotation shaft 82 (indicated by a broken line). With this configuration, it is easy to attach the blade unit 90 to the blade rotation shaft 82 with centers of the unit shaft 91 and the blade rotation shaft 82 aligned with each other. Furthermore, less unwanted rattling occurs when the blade rotation shaft 82 is rotated. In the present embodiment, the projecting portion 82b is provided on the blade rotation shaft 82 and the recess 91b is provided in the unit shaft 91, but instead, a recess may be provided in the blade rotation shaft 82 and a projecting portion may be provided on the unit shaft 91.

The grinding blade 92 for grinding cereal grains is, for example, is a product obtained by processing a stainless steel sheet. As shown in FIG. 10, the grinding blade 92 includes a first cutting portion 921, a second cutting portion 922, and a connection portion 923 which connects the first and second cutting portions 922 to each other. In a center portion of the connection portion 923, there is provided an opening 923a to be oval in plan view. The grinding blade 92 is attached to the unit shaft 91 by fitting the lower portion of the unit shaft 91 into the opening 923a.

At the lower portion of the unit shaft 91, there are provided flat surfaces which are obtained by cutting portion (close to the positions where the cuts 91a are provided) of a side surface of the unit shaft 91. With this configuration, when the unit shaft 91 is seen from below, the lower portion of the unit shaft 91 has a sectional shape that is substantially the same (oval) as the shape of the opening 923a provided in the connection portion 923. With such a shape adopted, the grinding blade 92 attached to the unit shaft 91 is relatively non-rotatable with respect to the unit shaft 91. A sectional area of the lower portion of the unit shaft 91 is slightly smaller than an area of the opening 923a, such that the unit shaft 91 and the grinding blade 92 are able to be fitted together. A disconnection-preventing stopper member 94 is fitted to the unit shaft 91 at a position below the grinding blade 92, and this prevents the grinding blade 92 from coming off from the unit shaft 9.

The dome-shaped cover 93 which is so arranged as to surround and cover the grinding blade 92 is, for example, a die-cast aluminum alloy product, and in an inside thereof, there is provided a recess-shaped mounting portion 931 (see FIG. 11B) for mounting therein a bearing 95 (in the present embodiment, a rolling-element bearing is used). In other words, with the mounting portion 931, the dome-shaped cover 93 is configured such that, as seen from outside, a substantially cylindrical projecting portion 93a is provided in a center portion thereof. No opening is provided in the projecting portion 93a, and the bearing 95 mounted in the mounting portion 931 is in a state such that side and upper surfaces thereof are surrounded by a wall surface of the mounting portion 931.

The bearing 95, with retaining rings 96a and 96b disposed over and under the bearing 95, has an internal ring 95a thereof attached to the unit shaft 91 to be relatively non-rotatable with respect to the unit shaft 91 (the unit shaft 91 is press-fitted in a through hole provided inside the internal ring 95a). Also, the bearing 95 is press-fitted in the mounting portion 931 such that an external wall of an external ring 95b thereof is fastened to a side wall of the mounting portion 931. By the interposition of the bearing 95 (where the internal ring 95a relatively rotates with respect to the external ring 95b), the dome-shaped cover 93 is attached to the unit shaft 91 to be relatively rotatable with respect to the unit shaft 91.

In the mounting portion 931 of the dome-shaped cover 93, for the purpose of preventing unwanted entry of substances (such as liquid used when cereal grains are ground or pasty substance obtained by the grinding) into the bearing 95 from outside thereof, a seal member 97 that is made of, for example, silicon or fluorine material, and a metal seal cover 98 which holds the seal member are press-fitted from under the bearing 95. The seal cover 98 is fastened to the dome-shaped cover 93 with rivets 99 for secure fastening of the seal cover 98 to the dome-shaped cover 93. The fastening by using the rivets 99 is not indispensable, but it is preferable in order to achieve secure fastening of the seal cover 98.

To an external surface of the dome-shaped cover 93, the mixing/kneading blade 101 (which is, for example, a die-cast aluminum alloy product) which is “<”-shaped in plan view is attached with a support shaft 100 (see FIG. 10) which is disposed at a position adjacent to the projecting portion 93a so as to extend in a vertical direction. The mixing/kneading blade 101 is attached to the support shaft 100 to be relatively non-rotatable with respect to the support shaft 100, and moves together with the support shaft 100 which is attached to the dome-shaped cover 93 to be relatively rotatable with respect to the dome-shaped cover 93. In other words, the mixing/kneading blade 10 is attached to be relatively rotatable with respect to the dome-shaped cover 93.

A cushioning member 107 is attached to a surface in the vicinity of an edge side of the mixing/kneading blade 101 (what is assumed here is a portion that moves along the largest circle when the mixing/kneading blade 101 rotates around the support shaft 100). The cushioning member 107 is so attached as to slightly project from the edge of the mixing/kneading blade 101 (see, for example, FIG. 12B). In the present embodiment, the cushioning member 107 projects from the edge by a length of the order of 3 mm (d 3 mm).

The cushioning member 107 is fastened to the edge the mixing/kneading blade 101 by first holding the cushioning member 107 between a side surface of the mixing/kneading blade 101 and a fastening plate 108, then inserting rivets 109 through them from the other side of the mixing/kneading blade 101, and then performing swaging. Two rivets 109 are used in the present embodiment, but needless to say, there is no limitation to the number of the rivets 109.

The cushioning member 107 is provided for the purpose of preventing the mixing/kneading blade 101 in the open position (which will be described later in detail) from coming in direct contact with (an internal wall of) the bread container 80. If the mixing/kneading blade 101 should come in direct contact with the bread container 80, the interference between them could cause a damage, and it is for the purpose of preventing such a damage that the cushioning member 107 is provided.

In the automatic bread machine 1 of the present embodiment, surfaces of the bread container 80 and the mixing/kneading blade 101 are coated with fluorine. Thus, it can be said that the cushioning member 107 of the present embodiment is provided for the purpose of preventing the fluorine coating from coming off due to contact between the mixing/kneading blade 101 and the bread container 80. In this view, the material of the cushioning member 107 is preferably softer than the coating material so as not to scrape off the fluorine coating, and for this reason, a material such as silicone rubber or a TPE (Thermoplastic Elastomers) is used. In addition, the cushioning member 107 helps reduce noise, and a detailed description of this function will be given later. Incidentally, some descriptions are given under the assumption that the cushioning member 107 is a portion of the mixing/kneading blade 101.

In the present embodiment, a supplementary mixing/kneading blade 102 (for example, a die-cast aluminum alloy product) is fastened to the external surface of the dome-shaped cover 93 so as to be aligned with the mixing/kneading blade 101. The supplementary mixing/kneading blade 102 is not indispensable, but it is preferable to provide the supplementary mixing/kneading blade 102 in order to achieve an enhanced mixing/kneading efficiency in the mixing/kneading step in which bread dough is kneaded.

Now, operation of the mixing/kneading blade 101 will be described. The mixing/kneading blade 101, together with the support shaft 100, rotates around an axis of the support shaft 100, and takes two positions, namely a folded position shown in FIGS. 9, 11A, 11B, 12A, and 13A and an open position shown in FIGS. 12B and 13B. The mixing/kneading blade 101 in the folded position is made to stop rotating by a stopper 93b which is provided on an internal surface of the dome-shaped cover 93, so that the mixing/kneading blade 101 is not able to rotate further in the counterclockwise direction (as seen from above) with respect to the dome-shaped cover 93. In the folded position, the edge of the mixing/kneading blade 101 projects slightly from the dome-shaped cover 93.

When the mixing/kneading blade 101 rotates clockwise with respect to the dome-shaped cover 93 (as seen from above) to change its position from the folded position (the state illustrated in FIG. 13A) into the open position illustrated in FIG. 13B, the edge of the mixing/kneading blade 101 projects greatly from the dome-shaped cover 93. An opening angle of the mixing/kneading blade 101 in the open position is also limited by the stopper 93b. When a second engagement body 103b (which is fastened to the support shaft 100), which will be described in detail later, hits the stopper 93b to stop the mixing/kneading blade 101 from rotating, the opening angle of the mixing/kneading blade 101 is at its maximum.

When the mixing/kneading blade 101 is in the folded position, as illustrated in FIG. 9 for example, the supplementary mixing/kneading blade 102 is aligned with the mixing/kneading blade 101, making it appear that the size of the “<” shaped mixing/kneading blade 101 is enlarged.

A first engagement body 103a (see FIG. 10), which constitutes a cover clutch 103, is attached to the unit shaft 91, at a position between the grinding blade 92 and the seal cover 98. The first engagement body 103a, which is a zinc die-cast product for example, has an opening 103aa which is oval in plan view, and by the lower portion of the unit shaft 91 which is the sectionally oval-shaped portion being fitted into the opening 103aa, the first engagement body 103a is made relatively non-rotatable with respect to the unit shaft 91. The first engagement body 103a, which is attached to the unit shaft 91 from the lower side of the unit shaft 91 before the grinding blade 92 is attached to the unit shaft 91, is prevented by the stopper member 94 from falling off from the unit shaft 91 together with the grinding blade 92. In the present embodiment, a washer 104 is disposed between the first engagement body 103a and the seal cover 98 in view of, for example, preventing deterioration of the first engagement body 103a, but the washer 104 is not indispensable.

To the lower portion of the support shaft 100 to which the mixing/kneading blade 101 is attached, the second engagement body 103b is attached, constituting the cover clutch 103 together with the first engagement body 103a. The second engagement body 103b, which is a zinc die-cast product for example, has an opening 103ba which is oval in plan view, and by the lower portion of the support shaft 100 which is the sectionally oval-shaped portion being fitted into the opening 103ba, the second engagement body 103b is made relatively non-rotatable with respect to the support shaft 100. In the present embodiment, a washer 105 is disposed over the second engagement body 103b in view of, for example, preventing deterioration of the second engagement body 103b, but the washer 105 is not indispensable.

The cover clutch 103, which is composed of the first and second engagement bodies 103a and 103b, functions as a clutch which switches between transmitting and not-transmitting the rotational force of the blade rotation shaft 82 to the dome-shaped cover 93. The cover clutch 103 transmits the rotational force of the blade rotation shaft 82 to the dome-shaped cover 93 in a direction in which the blade rotation shaft 82 rotates when the mixing/kneading motor 50 makes the drive shaft 11 rotate (rotation in this direction will be referred to as “forward rotation”; it is counterclockwise rotation in FIGS. 12A and 12B while it is clockwise rotation in FIGS. 13A and 13B). On the contrary, in a direction in which the blade rotation shaft 82 rotates when the grinding motor 60 makes the drive shaft 11 rotate (rotation in this direction will be referred to as “reverse rotation”; it is clockwise rotation in FIGS. 12A and 12B while it is counterclockwise rotation in FIGS. 13A and 13B), the cover clutch 103 does not transmit the rotational force of the blade rotation shaft 82 to the dome-shaped cover 93. The configuration and operation of the cover clutch 103 will be described below in more detail.

Two engagement portions are provided at two positions in a side surface of the second engagement body 103b. One of the two engagement portions is a first engagement portion 103bb which engages with the first engagement body 103a and the other one is a second engagement portion 103bc which engages with the stopper 93b.

When the mixing/kneading blade 101 is in the folded position (the state illustrated in, for example, FIGS. 12A and 13A), the first engagement portion 103bb of the second engagement body 103b is so angled as to interfere a rotational path of engagement portions 103ab (two engagement portions 103ab are provided in the present embodiment, but there may be provided only one engagement portion 103ab) of the first engagement body 103a, and the second engagement portion 103bc engages with the stopper 93b (see FIG. 12A). The stopper 93b functions as angle determining means for determining the angle when the mixing/kneading blade 101 is in the folded position.

When the blade rotation shaft 82 rotates forward in this state, one of the engagement portions 103ab of the first engagement body 103a and the first engagement portion 103bb of the second engagement body 103b engage with each other. In the second engagement body 103b, by the torque given by the blade rotation shaft 82 via the first engagement portion 103bb, moment to rotate around the support shaft 100 is created. This moment is received by the stopper 93b, and thus, the rotational force of the blade rotation shaft 82 is transmitted to the dome-shaped cover 93.

The force that is transmitted from the first engagement body 103a to the second engagement body 103b is received not only by the support shaft 100 to which the mixing/kneading blade 101 is attached but also by the dome-shaped cover 93 which holds the support shaft 100 through the engagement between the second engagement body 103b and the stopper 93b, and consequently, when the mixing/kneading blade 101 turns into the folded position to be ready for the mixing/kneading operation, the rotation force of the blade rotation shaft 82 is securely transmitted to the mixing/kneading blade 101.

On the other hand, in a case in which the mixing/kneading blade 101 is in the opening position (the state illustrated, for example, in FIGS. 12B and 13B), the first engagement portion 103bb of the second engagement body 103b is so angled as to be out of the rotation path of the engagement portions 103ab of the first engagement body 103a (see FIG. 12B). In this state, even when the blade rotation shaft 82 rotates, the first engagement body 103a and the second engagement body 103b do not engage with each other. Thus, the rotational force of the blade rotation shaft 82 is not transmitted to the dome-shaped cover 93. At this time, the second engagement portion 103bc of the second engagement body 103b is off from the stopper 93b.

As illustrated in FIGS. 9 and 10, in the dome-shaped cover 93, there are provided windows 93d to allow communication between inside and outside of the cover 93. The windows 93d are located as high as or above the grinding blade 92. In this embodiment, four windows 93d in total are arranged at intervals of 90°, but a different number of windows 93d may be arranged at different intervals.

On the internal surface of the dome-shaped cover 93, four ribs 93e in total are provided corresponding to the windows 93d (see FIGS. 12A and 12B). Each of the ribs 93e extends obliquely with respect to a radius direction of the dome-shaped cover 93 from near a center of dome-shaped cover 93 to a circumferential annular wall of the dome-shaped cover 93, the four ribs 93e being arranged in a kind of tomoe-formation (a formation that looks like a fan impeller). Furthermore, the ribs 93e are each curved such that a side thereof which faces the bread ingredients rushing thereto is convex.

A guard 106 is detachably attached to a bottom surface of the dome-shaped cover 93. The guard 106 covers the bottom surface of the dome-shaped cover 93 to prevent a finger of a user from approaching the grinding blade 92. The guard 106 is made of a heat-resistant engineering plastic, and may be a PPS (polyphenylene sulfide) product, for example. The guard 106 is not indispensable, but its provision is preferable in terms of, for example, ensuring user safety.

As illustrated in FIG. 10, at a center of the guard 106, there is provided a ring-shaped hub 106a through which the stopper member 94 which is fastened to the unit shaft 91 is placed. At a periphery of the guard 106, there is provided a ring-shaped rim 106b which is provided outside of the hub 106a to be concentric with the hub 106a. The hub 106a and the rim 106b are connected with each other with a plurality of spokes 106c. The plurality of spokes 106c are arranged at predetermined intervals, and spaces between the spokes 106c serve as openings 106d which pass cereal grains to be ground by the grinding blade 92. The openings 106d are each sized so as not to allow any finger to pass therethrough.

When the guard 106 is attached to the dome-shaped cover 93, the spokes 106c are located close to the grinding blade 92. In this state, it looks as if the guard 106 and the grinding blade 92 are an external blade and an internal blade, respectively, of a rotary electric shaver.

Along the rim 106b, four pillars 106e in total are integrally formed with the rim 106b at intervals of 90° (needless to say, this configuration is not meant as limitation). The pillars 106e each have a horizontal groove 106ea provided in a side surface thereof facing toward a center of the guard 106 such that one end of the groove 106ea is located at an edge of the side surface and the other end of the groove 106ea is a dead end. The guard 106 is attached to the dome-shaped cover 93 by engaging projections 93f (four projections 93f in total are arranged at intervals of 45°) into the grooves 106ea. Here, the grooves 106ea and the projections 93f are arranged to constitute a bayonet coupling, a detailed description of which will be omitted. In each of the plurality of pillars 106e, a side surface 106eb, which becomes a front surface in the rotation direction when the blade rotation shaft 82 rotates forward, is tilted obliquely upward.

Thus, the automatic bread machine 1 of the present embodiment has a configuration where the grinding blade 92 and the mixing/kneading blade 101 are incorporated in one unit (the blade unit 90), and this makes the automatic bread machine 1 handy. The user is able to easily detach the blade unit 90 from the blade rotation shaft 82, which allows the user to easily wash the blades after a breadmaking operation. In addition, the grinding blade 92 in the blade unit 90 is detachably attached to the unit shaft 91, easy to be mass-produced, and excellent in maintenance, which is evident in, for example, easy replacement of blades.

Since liquid such as water is placed in the bread container 80, it is preferable that the bearing 95 be sealed so that no liquid is allowed to enter the bearing 95. The automatic bread machine 1 is advantageous in this respect, because, since the bearing 95 is placed in the recessed mounting portion 931 which is provided in the dome-shaped cover 93, the bearing 95 is able to be sealed by providing sealing means (the seal member 97 and the seal cover 98) only inside the dome-shaped cover. Thus, there is no need of providing sealing means both over and below the bearing 95, which contributes to a compact configuration for sealing the bearing 95. As a result, with the automatic bread machine 1, it is possible to reduce the risk of adverse effects on the shape of baked bread (such as a great hollow in the bottom of bread).

Note that, in the bread container 140, to a projecting portion of the blade rotation shaft 142 which project to the inside of the bread container 140, an unillustrated mixing/kneading blade is detachably and relatively-unrotatably attached. This mixing/kneading blade is of a simple shape adopted in conventional automatic bread machines.

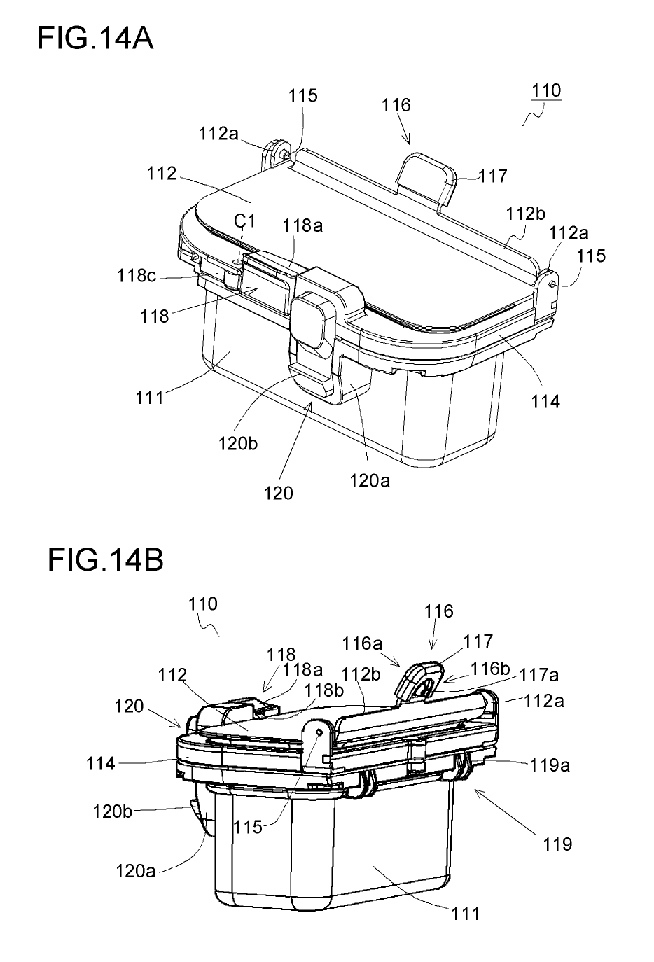

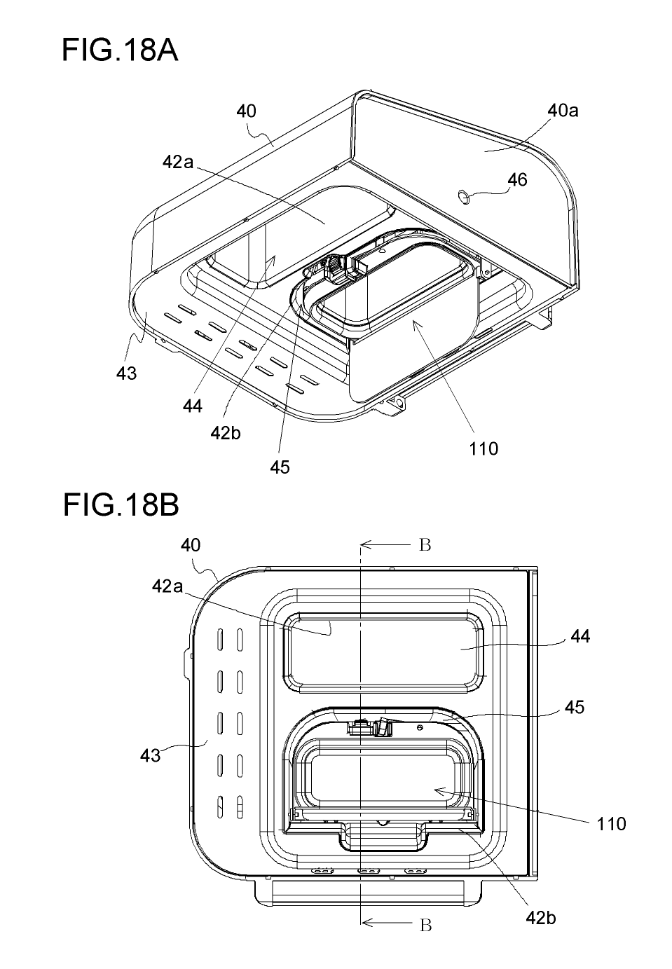

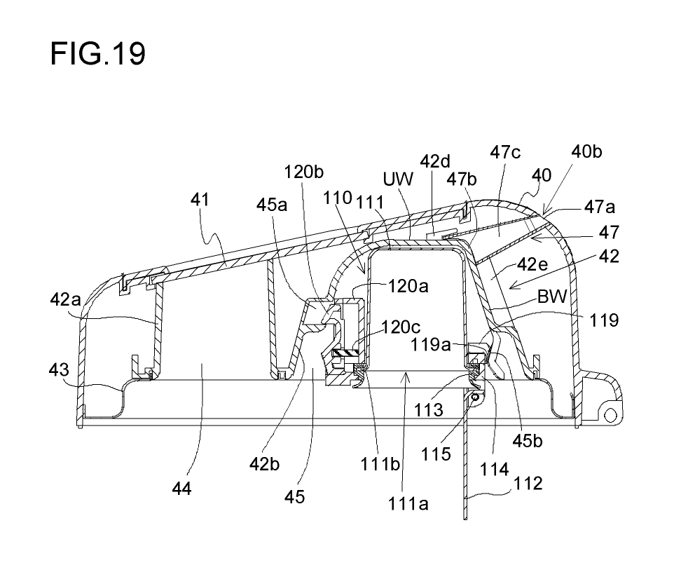

Now, descriptions will be given of a configuration of the bread ingredient dispenser 110 of the automatic bread machine 1 and a configuration for attaching the bread ingredient dispenser 110 to the lid 40, with reference to FIGS. 14A, 14B, 15, 16, 17, 18A, 18B, and 19. In the following descriptions, it is assumed that, in a state where the lid 40 to which the bread ingredient dispenser 110 is attached is closed (the state illustrated in FIG. 1), a surface that is located on the side of the front surface of the main body 10 is the front surface of the bread ingredient dispenser 110 and a surface that is located on the side of the rear surface of the main body 10 is the rear surface of the bread ingredient dispenser 110. Note that FIGS. 18A, 18B, and 19 illustrate a state in which the bread ingredient dispenser 110 is attached to the lid 40.

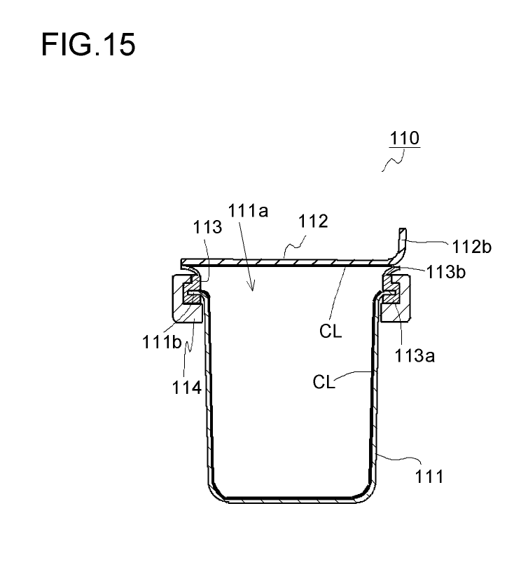

As shown in FIGS. 14A, 14B, and 15, for example, the bread ingredient dispenser 110 of the automatic bread machine 1 is provided with, as its main parts, a dispenser main body 111 and a dispenser lid 112 which is provided rotatable with respect to the dispenser main body 111 for opening/closing an opening 111a of the dispenser main body 111.

As shown in FIG. 15, the dispenser main body 111 is a box-shaped member whose sectional shape is substantially rectangular. The dispenser main body 111 is made of a metal such as aluminum or iron which is not very prone to static electricity for the purpose of reducing adhesion of powdered bread ingredients (such as gluten and dried yeast) to the inside of the dispenser main body 111. In addition, to minimize adhesion of the powdered bread ingredients to the inside of the container, an internal surface of the dispenser main body 111 is covered with a coating layer CL which is made of silicon or fluorine material, for example. It is preferable that unevenness be prevented from being caused on the internal surface of the dispenser main body 111 by rivets and screws such that the internal surface of the dispenser main body 111 is a smooth surface.

Furthermore, as shown in FIG. 15, the dispenser main body 111 is provided with a brim portion (a flange) 111b which projects outward from an edge of the opening 111a. The flange 111b is provided all along the dispenser main body 111. A gasket (an embodiment of the sealing member) 113 is fastened to the flange 111b; the gasket 113 is a silicon gasket, for example.

The gasket 113 is substantially frame-shaped in plan view, and the gasket 113 is fastened to the flange 111b all around the flange 111b. More in detail, the gasket 113 has two portions: a sectionally substantially right-angled U-shaped portion 113a which is fitted to the flange 111b by sandwiching the flange 111b in an up-down direction; and a thin elastic portion 113b which projects (upward in FIG. 15) from the sectionally substantially right-angled U-shaped portion and is folded such that an edge thereof points a direction opposite from the opening 111a.

Protrusion of the gasket 113 into the opening 111a of the dispenser main body 111 would cause bread ingredients placed in the dispenser main body 111 to be easily caught by the gasket 113, resulting in residual bread ingredients remaining in the container. To prevent this inconvenience, in the present embodiment, the gasket 113 is fitted to the dispenser main body 111 such that it does not protrude into the opening 111a. Furthermore, fixation of the gasket 113 to the dispenser lid 112 side would cause the bread ingredients to be easily caught by the gasket 113 when the bread ingredients are fed into the bread container 80, resulting in inaccurate supply of the bread ingredients. In view of these inconveniences, the gasket 110 is fastened to the dispenser main body 111 side.

The gasket 113 is fastened to the dispenser main body 111 (the flange 111b) by a dispenser cover 114 which is attached to the dispenser main body 111 to hold therein the sectionally substantially right-angled U-shaped portion 113a. That is, the dispenser cover 114 functions as a fastening member for fastening the gasket 113 to the dispenser main body 111. More in detail, the dispenser cover 114 is composed of two parts; these two parts are so arranged as to sandwich the flange 111b together with the gasket 113 and then screw fastened, to thereby achieve fastening of the gasket 113 by the dispenser cover 114. Although there is no particular limitation to the material of the dispenser cover 114, the dispenser cover 114 is made of, for example, polybutylene terephthalate (PBT) containing glass filler dispersed therein.

The dispenser lid 112 is made of a metal plate which is substantially rectangular-shaped and is slightly larger than the opening 111a of the dispenser main body 111. The dispenser lid 112 is made of metal such as aluminum for the same reason as in the case of the dispenser main body 111 (to reduce adhesion amount of powdered bread ingredients). Further, for the same reason as in the case of the dispenser main body 111, an internal surface of the dispenser lid 112 (an expression on an assumption that the dispenser lid 112 is in a closed state) is covered with a coating layer CL which is made of a silicon material or the like.

The dispenser lid 112 is provided with, as shown in FIGS. 14A and 14B, two attaching portions 112a which are provided at both ends of the dispenser lid 112 at the rear surface side (at one edge side) and each have an engagement hole. The attaching portions 112a are made by bending part of the dispenser lid 112. Into the engagement holes of the attaching portions 112a, support shafts 115 (provided at both ends at the rear surface side) are fitted to be stationary with respect to the dispenser main body 111. And thereby, the dispenser lid 112 has a portion thereof at the rear surface side (one edge side) supported by the support shafts 115, which are stationary with respect to the dispenser main body 111, such that a portion thereof at the front surface side (another edge side that is opposite from the one edge side) is rotatable to approach and move away from the opening 111a.

At the rear surface side of the dispenser lid 112, there is provided a bent portion 112b which is obtained by bending part of the edge portion of the dispenser lid 112 to be away from the opening 111a (in the present embodiment, by substantially 90°). The bent portion 112b is not indispensable, but it is preferable to provide the bent portion 112b, because it helps prevent an edge surface of the dispenser lid 112 from getting stuck with, or damaging, the gasket 113 when the dispenser lid 112 is opened.

As shown in FIGS. 14A and 14B, a projection 116, which is substantially rectangular in plan view, projects obliquely upward (outward) substantially from a center of an edge of the bent portion 112b of the dispenser lid 112. In the present embodiment, the projection 116 is integrally formed with the dispenser lid 112, but this is not meant as limitation; the dispenser lid 112 and the projection 116 may be formed as different members.

The projection 116 is provided such that it projects from the dispenser lid 112 at a position (at a position located to the right of the support shaft 115 in FIG. 6) that is located outward from the support shafts 115 (function as a rotation center of the dispenser lid 112). This makes it possible to easily rotate the dispenser lid 112 into an open state by pressing a front surface 116a (see FIG. 14B) of the projection 116. That is, the projection 116 has a function of assisting (the user) in an operation of opening the dispenser lid 112. The size and shape of the projection 116 may of course be changed as necessary.

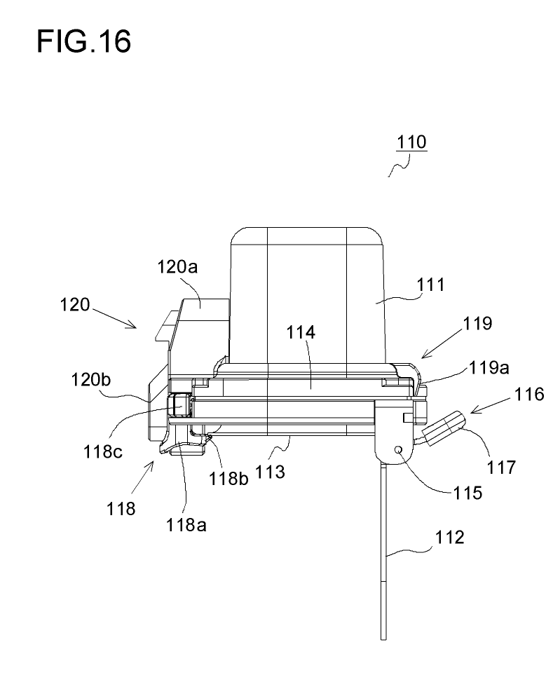

The projection 116 is also provided to exert a stopper function as described below. The bread ingredient dispenser 110 is in the position illustrated in FIG. 16 when the automatic bread machine 1 is in operation. That is, the bread ingredient dispenser 110 is used in such a position that the dispenser lid 112 is located below the dispenser main body 111. Thus, the dispenser lid 112 rotates under its own weight around the support shafts 115 to move from its closed position to the open position (which is the state illustrated in FIG. 16). When the dispenser lid 112 is opened, if the opening angle is too large, a disadvantageously increased amount of bread ingredients falls out of the bread container 80 without being thrown into the bread container 80. To prevent this disadvantage, the projection 116 is designed to hit the dispenser main body 111 (specifically, a portion of the dispenser cover 114) to prevent the dispenser lid 112 from opening (rotating) to a certain angle (in the present embodiment, 95° with respect to the opening plane of the dispenser main body 111) or wider. That is, the projection 116 functions as a stopper which regulates the opening angle (amount) of the dispenser lid 112.

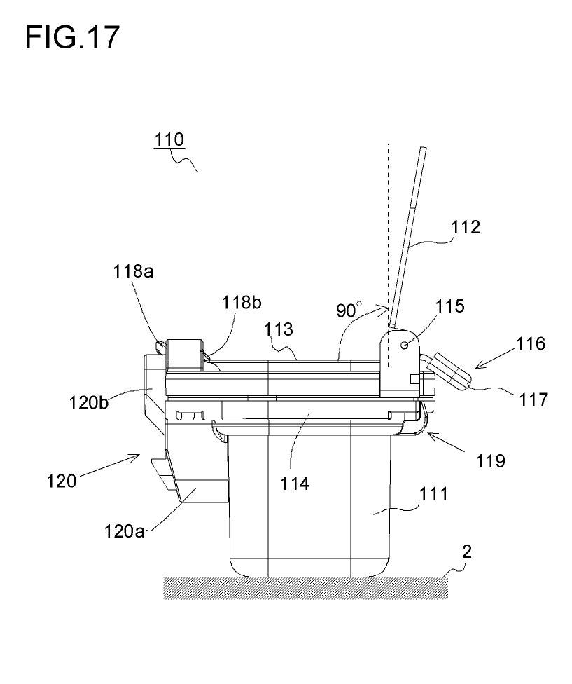

Here, if the projection 116 regulates the opening angle of the dispenser lid 112 to be too narrow, it will invite the following problems. As illustrated in FIG. 17, in placing bread ingredients in the bread ingredient dispenser 110, the bread ingredient dispenser 110 is presumably placed on a platform 2 in such a position that the dispenser main body 111 is below the dispenser lid 112. If the projection 116 regulates the opening angle to make the opening angle of the dispenser lid 112 too narrow, the user needs to hold the dispenser lid 112 by hand to place the bread ingredients in the dispenser main body 111.

To prevent this inconvenience, in the present embodiment, as described above, a position for regulation of the opening amount of the dispenser lid 112 by the projection 116 is adjusted such that the maximum value of the opening angle is wider than 90°, specifically, 95°. This makes it easier for the user to place the bread ingredients in the dispenser main body 111 while keeping the dispenser lid 112 open without holding it by hand as illustrated in FIG. 17.

Note that the regulation value of the opening angle is given merely as an example, and needless to say, various modifications and variations are possible as long as the configuration of the projection 116 is adjusted to minimize the amount of the bread ingredients falling out of the bread container 80 while maintaining a satisfactory workability in putting the bread ingredients in the bread ingredient dispenser 110. The configuration for making it possible to keep the dispenser lid 112 open without holding it can be achieved by, for example, adopting a slope configuration in a bottom surface (assuming that the bread ingredients into the bread ingredient dispenser 110 is placed as illustrated in FIG. 17) of the dispenser main body 111. The opening amount of the dispenser lid 112 may be adjusted by adopting such a configuration.

An elastic cover member 117 made of a material such as silicon is applied to the projection 116. The cover member 117 is not indispensable, but it is preferable to provide it for the purpose of protecting the user's fingers, for example. Further, as described above, the projection 116 is designed to hit the dispenser main body 111 (more specifically, a portion of the dispenser cover 114) to thereby regulate the opening amount of the dispenser lid 112. Shock that the projection 116 receives when it hits the dispenser main body 111 can be alleviated (and noise caused by the collision can also be reduced) by equipping the projection 116 with the elastic cover member 117. In these respects as well, it is preferable to provide the cover member 117.

The cover member 117 may be configured as a hollow member having one end thereof open such that it is simply put on the projection 116, but in the present embodiment, the cover member 117 has an engagement projection 117a which is fitted into an engagement hole provided in the projection 116 such that the cover member 117 does not come off easily (see FIG. 14B). And, when the dispenser lid 112 is opened to a certain angle (in the present embodiment 95°), the engagement projection 117a fitted into the engagement hole provided in the projection 116 comes in contact with a portion of the dispenser cover 114 which is fitted to the dispenser main body 111.

To a portion of the dispenser cover 114 on the front surface side of the bread ingredient dispenser 110, a movable lock member 118 is attached. The lock member 118 has a finger-placing portion 118a having a finger-placing surface which is substantially L-shaped in side view (see, for example FIG. 16), a hook portion 118b which projects from the finger-placing portion 118a toward the opening 111a of the dispenser main body 111 so as to be able to press the dispenser lid 112 from an external-surface side of the dispenser lid 112, and an arm portion 118c which extends from the finger-placing portion 118a in a direction that is substantially parallel to a longitudinal direction of the dispenser main body 111.

The arm portion 118c is supported on the dispenser cover 114 by a rotation shaft C1 (see FIG. 14A) which is substantially parallel to a depth direction of the dispenser main body 111 to be rotatable around the rotation shaft C1. A pressing force is applied to a one end-side portion of the arm portion 118c by an unillustrated pressing member, and the finger-placing portion 118a and the hook portion 118b disposed at the other end side of the arm portion 118c is pressed by the pressing force toward the opening 111a of the dispenser main body 111.

The hook portion 118b is substantially triangular in section and designed such that, if a downward force (an expression assuming the positions illustrated in FIGS. 14A, 14B and 17) is applied to the hook portion 118b with the dispenser lid 112 placed thereon, a force is generated against the pressing force applied to the arm portion 118c by the pressing member. Thus, if a downward force is applied when the dispenser lid 112 is placed on the hook portion 118b, in the state in which the dispenser lid 112 is placed on the hook portion 118b, the arm portion 118c is made to rotate against the pressing force of the pressing member, and the hook portion 118b moves in a direction away from the dispenser lid 112. And, when the dispenser lid 112 comes into a state where it is no longer on the hook portion 118b, since the arm portion 118c is made to rotate by the pressing force of the pressing member, the hook portion 118b moves toward the container lid to reach a position at which the hook portion 118b presses the dispenser lid 112 from the external-surface side of the dispenser lid 112. Thereby, a locked state (a state in which the dispenser lid 112 is kept closed) is obtained.

In the locked state, as illustrated in FIG. 15, a peripheral portion of the internal surface of the dispenser lid 112 overlaps the flange 111b in a state in which the portion is in contact with the elastic portion 13b of the gasket 113, and thus the opening 111a is completely covered. In the locked state, space between the flange 111b and the dispenser lid 112 is sealed with the gasket 113, and this makes it difficult for external substances such as water and dust to enter the dispenser main body 111.

The locked state is released to open the opening 111a of the dispenser main body 111 by applying an external force to the arm portion 118c to rotate the arm portion 118c against the pressing force (rotation around the rotation shaft C1) to thereby move the hook portion 118b to a position at which the hook portion 118b does not press the dispenser lid 112 from the external-surface side of the dispenser lid 112. Then, the dispenser lid 112 is made to rotate by the gravity (an expression on the assumption of the state illustrated in FIG. 16), and thereby a state in which the opening 111a is open (open state) is obtained.

In the automatic bread machine 1 of the present embodiment, an unillustrated automatic supply solenoid is provided inside the main body 10, in a portion of the main body 10 below the operation portion 20 (see FIG. 1). When the solenoid is driven, a plunger thereof projects from an opening 10b (see FIG. 1B) provided in a main-body wall surface that is adjacent to the lid 40. Then, the projected plunger presses a movable member 46 (see FIG. 18A) which is provided at a side wall 40a of the lid 40. By being pressed in this way, the movable member 46 moves to press the arm portion 118c of the lock member 118, and thereby, the arm portion 118c rotates against the pressing force of the unillustrated pressing member. Thereby, the holding of the dispenser lid 112 by the hook portion 118b is released, such that the dispenser lid 112 rotates due to gravity into a state in which the opening 111a is opened.

In a case in which the user opens the dispenser lid 112 of the bread ingredient dispenser 110 by himself/herself, the user places one of his/her fingers (for example, the left-hand thumb) on the finger-placing surface of the finger-placing portion 118a, and then applies a force outward (leftward in FIG. 17). Thereby, the arm portion 118c of the lock member 118 is made to rotate, and the hook portion 118b moves to a position at which it does not press the external surface of the dispenser lid 112. Then, in this state, the user presses the projection 116 outward (rightward in FIG. 17) by his/her finger (for example, the right-hand thumb), to thereby obtain a state in which the dispenser lid 112 is open. That is, the provision of the finger-placing portion 118a and the projection 116 makes it possible for the user to easily open the dispenser lid 112. Since the finger-placing surface thereof for placing a finger thereon is L-shaped in side view as described above, the finger-placing portion 118a fits and holds a finger well.

The dispenser cover 114 of the bread ingredient dispenser 110 has, as illustrated in FIGS. 14A and 14B, a first engagement portion 119 provided at the rear-surface side and a second engagement portion 120 provided at the front-surface side so that the bread ingredient dispenser 110 can be held by the lid 40. That is, the first and second engagement portions 119 and 120 constitute an attaching mechanism for attaching the bread ingredient dispenser 110 to the lid 40.

The first engagement portion 119 has a first engagement slope 119a which projects outward (projects obliquely upward in FIG. 19) from a side surface of the dispenser cover 114. As the first engagement portion 119, a total of four first engagement portions 119 are provided in two pairs which are disposed at two positions in the vicinity of the both ends of the rear surface side; the two first engagement portions 119 of each of the two pairs are arranged close to each other. It should be understood that the number and the arrangement of the engagement portions 119 are just an example and may be changed as necessary.

The second engagement portion 120 has a housing portion 120a and an attaching hook portion (movable hook portion) 120b part of which is placed inside the housing portion 120a. A pressing force is applied to the attaching hook portion 120b by a pressing member 120c (see FIG. 19) which is provided inside the housing portion 120a such that the attaching hook portion 120b is pressed outward in a direction that is substantially parallel to a shorter-side direction of the dispenser main body 111 (leftward in FIG. 19). If a force is applied to the attaching hook portion 120b in a direction (rightward in FIG. 19) opposite to the direction in which the pressing force is applied by the pressing member 120c, the attaching hook portion 120b is movable in the direction, and the attaching hook portion 120b projects by a variable amount from the housing portion 120a.

Inside the lid 40 of the automatic bread machine 1, a frame member 42 (for example, a die-cast aluminum-alloy product) is disposed, and the frame member 42 is supported by an inner cover 43 (made of, for example a sheet metal) from the rear surface side of the lid 40. The frame member 42 is an example of a holding member having an accommodation space into which the bread ingredient dispenser 110 is able to be detachably fitted.

In a case in which the lid 40 is in a closed state, in a portion of the frame member 42 close to the front surface of the main body 10, there is provided a through hole 44 which is surrounded by a wall portion 42a and has a substantially rectangular shape (a case in which the lid 40 is viewed from the rear surface side is assumed). The wall portion 42a is in contact with the viewing window 41 disposed at an upper surface side of the lid 40 and thereby supports the viewing window 41. Here, specifically, the through hole 44 is configured such that its area is gradually smaller toward the viewing window 41 when viewed in plan toward the viewing window 41.

With this configuration, when the user looks through the viewing window 41 into the bread container 80 placed inside the baking chamber 30, the user is able to obtain a clear view of the inside of the bread container 80 without seeing other parts, because the wall portion 42a hides the structure inside the lid 40. Note that, in the present embodiment, the viewing window 41 is significantly larger than the through hole 44 for a better design (this configuration is not meant as a limitation, and instead, for example, the through hole 44 and the viewing window 41 may be substantially equal in size). With this configuration, the internal structure of the lid 40 is visible outside the wall portion 42a; however, it is possible to make the internal structure of the lid 40 invisible, for example, by applying printing to an upper surface of the viewing window 41.

Furthermore, the frame member 42 includes a space 45; the space 45, which is defined by a dome-shaped wall 42b, is located close to the rear surface of the main body 10 in a state in which the lid 40 is closed. The space 45 is an accommodation space into which the bread ingredient dispenser 110 is able to be detachably fitted. In a front portion (on a left side in FIG. 19) of the accommodation space 45, there is provided an engagement groove 45a which engages with the attaching hook portion 120b of the second engagement portion 120 when the bread ingredient dispenser 110 is placed in the space 45. Moreover, at a rear portion of the accommodation space 45 (on a right side in FIG. 19), there is provided a second engagement slope 45b which is designed to be substantially parallel with, and comes in contact with, the first engagement slope 119a when the bread ingredient dispenser 110 is housed in the space 45.

In setting the bread ingredient dispenser 110 in the space 45, the user applies a force in a direction in which the attaching hook portion 120b of the second engagement portion 120 retracts into the housing portion 120a (that is, a direction opposite to the direction of the pressing force of the pressing member 120c). Then, with the attaching hook portion 120b projecting by a reduced amount from the housing portion 120a, the user obliquely pushes the bread ingredient dispenser 110 into the accommodation space 45 such that the first engagement slope 119a does not collide against the second engagement slope 45b. Thereafter, the user reduces the force which he/she has been applying to the attaching hook portion 120b, to let the attaching hook portion 120b project, such that the attaching hook portion 120b and the engagement groove 45a engage with each other.

In this manner, when the bread ingredient dispenser 110 is fitted in the accommodation space 45, in a case in which the lid 40 is in the closed state (as illustrated in FIG. 19), the first engagement slope 119a and the second engagement slope 45b come in contact with each other. In this state, the bread ingredient dispenser 110 receives, from the second engagement slope 45b, a force in a vertically upward direction (an upward direction in FIG. 19) and a force (a force in a leftward direction in FIG. 19) in a direction opposite to a direction for releasing the engagement of the attaching hook portion 120b in the engagement groove 45a. As a result, the bread ingredient dispenser 110 is supported in the accommodation space 45 by the engagement groove 45a which is in engagement with the attaching hook portion 120b and the second engagement slope 45b which is in contact with the first engagement slope 119a, to be thereby held within the accommodation space 45.

In detaching the bread ingredient dispenser 110 from the accommodation space 45, the user pushes the attaching hook portion 120b in a direction in which the housing portion 120a retracts into housing portion 120a to thereby release the engagement between the attaching hook portion 120b and the engagement groove 45a. Then, the user obliquely pulls out the bread ingredient dispenser 110 in such a manner that the first engagement slope 119a is not disturbed by the second engagement slope 45b. That is, the user is able to easily attach and detach the bread ingredient dispenser 110 to and from the lid 40 simply by pushing a portion of the attaching hook portion 120b.

In a case, for example, where the second engagement portion 120 having the attaching hook portion 120b, the lock member 118, and the like are provided not in the dispenser cover 114 but in the dispenser main body 111, there is a possibility that a surface inside the dispenser main body 111 is caused to be irregular as a result of fastening such portions and members (by using rivets or the like). Such a case is not preferable, because bread ingredients are apt to remain inside the dispenser main body 111 in which powdered bread ingredients are placed (it should be noted, however, that the present invention does not exclude such a configuration). The bread ingredient dispenser 110 according to the present embodiment, in which the second engagement portion 120, the lock member 118, and the like are provided in the dispenser cover 114, is able to avoid the above-mentioned problem.

Now, the lid 40 of the automatic bread machine 1 is provided with an exhaust path, which is a configuration that features the automatic bread machine according to the present invention. Note that the exhaust path here is one through which vapor, heat, and the like generated in the baking chamber 30 are discharged. Hereinafter, a description will be given of the exhaust path.

As shown in FIG. 19 (in which the lid 40 is illustrated in a closed state), a duct 47 is disposed between the frame member 42 and the lid 40. The duct 47 is provided with a first opening 47a which is provided at one end of the duct 47, a second opening 47b provided at the other end of the duct 47, and a hollow space 47c which links the first opening 47a and the second opening 47b to each other (see FIG. 19). The end of the duct 47 at which the first opening 47a is provided is, as shown in FIG. 19, fitted into an exhaust port 40b (substantially rectangular in plan view) which is provided at a position in an upper portion, close to the rear surface, of the lid 40 of the automatic bread machine 1.

The duct 47 is gradually thicker from the one end thereof at which the first opening 47a is provided toward the other end thereof at which the second opening 47b is provided, such that the duct 47 is not allowed to project outside from the exhaust port 40b.

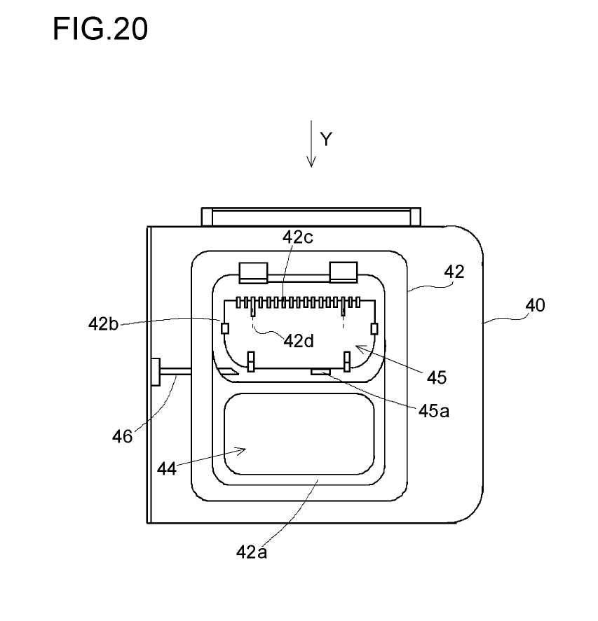

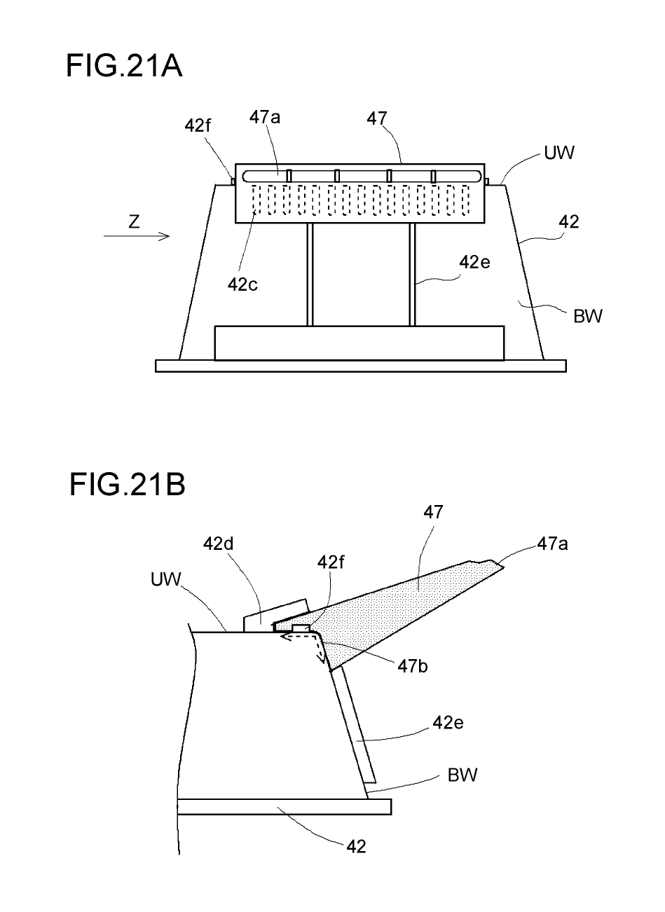

FIG. 20 is a schematic plan view illustrating a configuration of a lid of an automatic bread machine according to the present embodiment, and FIG. 20 illustrates the lid as seen from a lower surface side of the lid after an inner cover (denoted by the reference number 43 in FIGS. 18A, 18B, and 19) and a bread ingredient dispenser are detached. FIGS. 21A and 21B are schematic plan views for describing a relationship between a frame member and a duct of the automatic bread machine according to the present embodiment; FIG. 21A is a diagram obtained by viewing as indicated by arrow Y in FIG. 20, and FIG. 21B is a diagram obtained by viewing as indicated by arrow Z in FIG. 21A. Note that, in FIGS. 21A and 21B, the upper surface side of the lid is located on the upper side of the figures and the lower surface side of the lid is located on the lower side of the figures.

As illustrated in FIG. 20, in a portion of the wall 45b that defines the accommodation space 45 of the frame member 42, a plurality of exhaust through holes 42c are provided. In the automatic bread machine 1 of the present embodiment, assuming that the lid 40 is in a closed state (a state illustrated in, for example, FIG. 19), each of the plurality of exhaust through holes 42c has a configuration such that a through hole provided in an upper wall UW at a position close to a rear surface of the frame member 42 (on the right side in FIG. 19) and a through hole provided in a side wall BW, which is at the rear surface side of the frame member 42, at a position close to an upper portion of the side wall BW are connected with each other. It should be understood that the configuration of the present embodiment is not meant as a limitation, and the number and shape of the exhaust through holes 42c provided in the frame member 42 may be determined as necessary.

As illustrated in FIGS. 21A and 21B, the plurality of exhaust through holes 42c provided in the frame member 42 are concealed by an end of the duct 47 at which the second opening 47b is provided. Incidentally, in FIG. 21B, broken-line arrows indicate a range (a maximum range) over which the exhaust through holes 42c are provided.

As shown in FIG. 19 (a sectional view) and FIG. 21B (a side view), the end of the duct 47 at which the second opening 47b is provided is configured such that an upper portion thereof projects more than a lower portion. Furthermore, as shown in FIG. 21B, a side surface of the end of the duct 47 at which the second opening 47b is provided is configured to curve to fit the upper wall UW and a rear side wall BW of the frame member 42. With this configuration, the duct 47 is able to completely conceal the plurality of through holes 42c which are provided in the frame member 42.

At an external surface side of the upper wall UW of the frame member 42, there is provided an engagement projection 42d for fastening an upper portion of the duct 47 at the end thereof at which the second opening 47b is provided. As shown in FIG. 21B, the engagement projection 42d is lateral L-shaped in side view. The duct 47 is attached to the frame member 42 such that the upper portion of the duct 47 at the end thereof at which the second opening 47b is provided is held in a space between the engagement projection 42e and the upper wall UW of the frame member 42.

Also, the duct 47 is attached to the frame member 42 such that a lower portion of the duct 47, at the end thereof at which the second opening 47b is provided, is supported by a projecting part 42e provided on an external surface of the rear side wall BW of the frame member 42. With this configuration, the duct 47 is fastened between the frame member 42 and the lid 40 without using a fastening member such as a screw or a rivet.

As shown in FIG. 20, in the present embodiment, a total of two engagement projections 42d are provided at two positions. The number and shape of the engagement projections 42d are not limited to those of the present embodiment, but changeable as necessary. In FIG. 20, only the inside of the frame member 42 is visible, and thus the engagement projections 42d provided on the external surface side are indicated by broken lines. Furthermore, in the present embodiment, as shown in FIG. 21A, a total of two projecting parts 42e are provided at two positions. The number and shape of the projecting parts 42e are not limited to those of the present embodiment, but changeable as necessary. Preferably, the engagement projections 42d and the projecting parts 42e are integrally formed with the frame member 42, but this is not meant as a limitation.

In the present embodiment, two positioning projections 42f (see FIG. 21A) are provided on the upper wall UW of the frame member 42 to prevent the duct 47 which is attached to the frame member 42 from being displaced. This helps prevent the duct 47 from being displaced and makes it easy to attach the duct 47 to the frame member 42.

In the automatic bread machine 1 configured as described above, steam, heat, and the like generated in the baking chamber 30 pass through the exhaust through holes 42c provided in the frame member 42, to enter the duct 47 via the second opening 47b of the duct 47. Then, the steam and the liked that have entered the duct 47 reach the exhaust port 40b provided in the lid 40 via the first opening 47a which faces the second opening 47b of the duct 47, to be discharged to outside of the automatic bread machine 1.

In the automatic bread machine 1 of the present embodiment, the duct 47 and the frame member 42 are separate members, and thus the frame member 42 is able to have a simple shape, which helps reduce increase in metal-mold cost. Furthermore, since the exhaust port 40b, which is provided in the lid 40, is provided at a position in the top surface of the lid 40 close to the rear surface side (a case is assumed in which the lid 40 is in the closed position), the exhaust port 40b is disposed at a position away from the user. This helps prevent a situation where the steam and the like are discharged from the exhaust port 40b toward the user, which is preferable. Moreover, the exhaust port 40b is so located as to make it difficult for the user to see the exhaust port 40b, and this is preferable designwise.

Besides, since the exhaust through holes 42c which are provided in the frame member 42 are located to be close to the rear surface side, and thus are located close to the exhaust port 40b, it is easy to simplify the configuration of the duct 47 through which the exhaust port 40b communicates with the through holes 42c provided in the frame member 42. As a result, it is easy to reduce the cost of the automatic bread machine 1. In addition, since the configuration of the duct 47 is able to be simplified as described above, the automatic bread machine 1 is excellent in ease of assembly. Furthermore, since no fastening member such as a screw or a rivet is used to attach the duct 47, the exhaust path is able to be assembled easily.

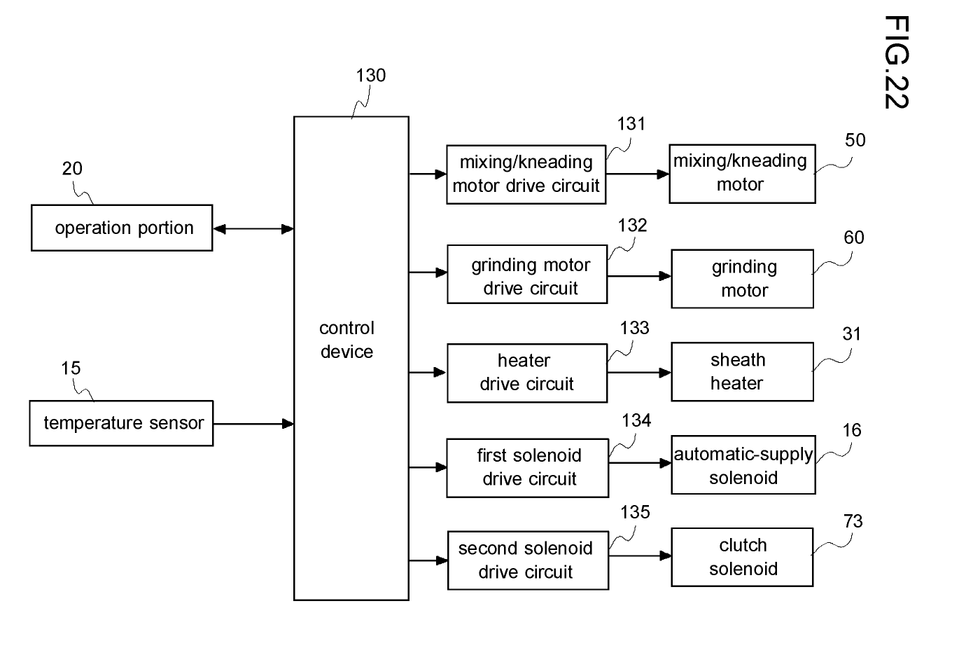

FIG. 22 is a block diagram illustrating the configuration of the automatic bread machine 1. The automatic bread machine 1 is controlled by a control device 130. The control device 130 is configured with a microcomputer (a micon) that has components such as a CPU (Central Processing Unit), a ROM (Read Only Memory), a RAM (Random Access Memory), and an I/O (input/output) circuit. The control device 130 is preferably located at a position at which it is not likely to be influenced by heat from the baking chamber 30. The control device 130 is provided with a time-counting function, and is capable of performing time control in the bread-making process.

To the control device 130, the above-described operation portion 20, a temperature sensor 15 which detects temperature of the baking chamber 30, a mixing/kneading motor drive circuit 131, a grinding motor drive circuit 132, a heater drive circuit 133, a first solenoid drive circuit 134, and a second solenoid drive circuit 135 are electrically connected.

The mixing/kneading motor drive circuit 131 controls the driving of the mixing/kneading motor 50 according to instructions from the control device 130. The grinding motor drive circuit 132 controls the driving of the grinding motor 60 according to instructions from the control device 130. The heater drive circuit 133 controls the driving of the sheath heater 31 according to instructions from the control device 130. According to instructions from the control device 130, the first solenoid drive circuit 134 controls the driving of an automatic supply solenoid 16 which is driven to automatically dispense some of bread ingredients in the course of the bread-making process. The second solenoid drive circuit 135 controls, according to instructions from the control device 130, the driving of the clutch solenoid 73 (see FIGS. 3A and 3B) which switches the state of the clutch 56 (see FIGS. 3A and 3B).

Based on a signal received from the operation portion 20, the control device 130 reads a program related to a course of making bread (a bread-making course) stored in the ROM, for example, to make the automatic bread machine 1 perform the bread-making process; in doing so, the control device 130 controls, via the mixing/kneading motor drive circuit 131, rotation of the mixing/kneading blade 101 and rotation of the supplementary mixing/kneading blade 102 which are driven by the mixing/kneading motor 50, the control device 130 controls, via the grinding motor drive circuit 132, rotation of the grinding blade 92 which is driven by the grinding motor 60, the control device 130 controls, via the heater drive circuit 133, heating operation performed by the sheath heater 31 and controls, via the first solenoid drive circuit 134, operation of a lock mechanism 118 performed by the automatic supply solenoid 16, and the control device 130 controls, via the second solenoid drive circuit 135, switching of the clutch 56 performed by the clutch solenoid 73.

(Operation of Automatic Bread Machine)

Next, a description will be given of a bread-making process performed by the automatic bread machine 1 configured as described above. Here, the operation of the automatic bread machine 1 will be described dealing with a case in which bread is made by the automatic bread machine 1 by using rice grains as a starting ingredient.

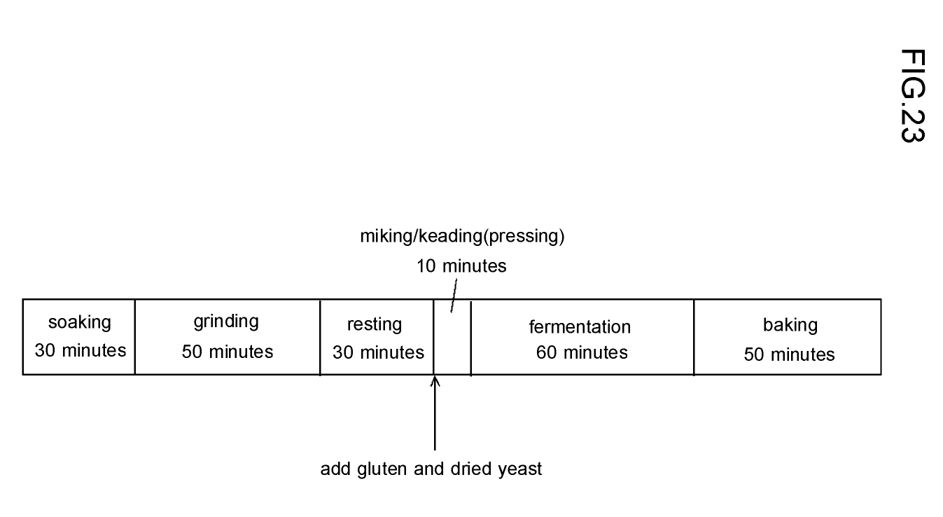

In the case in which rice grains are used as the starting ingredient, the bread container 80 is set in the baking chamber 30. Then, according to the time chart of FIG. 23, a bread-making course using rice grains is carried out. The bread-making course using rice grains includes a soaking step, a grinding step, a resting step, a mixing (kneading) step, a fermentation step, and a baking step, which are carried out one after another in this order.

To start the bread-making course using rice grains, the user attaches the blade unit 90 to the blade rotation shaft 82 by placing the unit shaft 91 on the blade rotation shaft 82 of the bread container 80. Here, as described above, since the blade unit 90 is provided with the guard 106, the fingers of the user is prevented from touching the grinding blade 92, and thus the user is able to carry out this operation safely. After attaching the blade unit 90 in this way, the user measures predetermined amounts of rice grains, water, and seasonings (such as salt, sugar, and shortening), and place them in the bread container 80.

The user measures some of bread ingredients to be automatically supplied in the course of the bread-making process, and place them in the bread ingredient dispenser 110. Examples of such bread ingredients that are placed in the bread ingredient dispenser 110 include gluten and dried yeast. Instead of gluten, at least one of wheat flour, a thickener (such as guar gum), and Joshinko (flour made from non-glutinous rice) may be placed in the bread ingredient dispenser 110. Furthermore, without using any of gluten, wheat flour, a thickener, Joshinko, and the like, dried yeast alone, for example, may be placed in the bread ingredient dispenser 110. Moreover, seasonings such as salt, sugar, and shortening may be placed in the bread ingredient dispenser 110 together with gluten and dried yeast as necessary, to be automatically supplied in the course of the bread-making process. In this case, the bread ingredients that are placed in the bread container 80 at the beginning are rice grains and water (instead of water, liquid such as broth containing a taste component, fruit juice, and a liquid containing alcohol may be used).

Thereafter, the user places the bread container 80 in the baking chamber 30, and further, he/she sets the bread ingredient dispenser 110 in the lid 40. Then, the user closes the lid 40, selects the bread-making course using rice grains on the operation portion 20, and presses the start key. In response to this, the control device 130 starts an operation of controlling the bread-making course using rice grains in which rice grains are used as a starting ingredient to make bread.

Here, the bread container 80 can be smoothly attached to the baking chamber 30 thanks to the presence of the main body-side guide portions 32 and the bread container-side guide portions 84. In particular, the main body-side guide portions 32 extend to the vicinity of the upper end portion of the baking chamber 30. With this configuration, the main body-side guide portions 32 starts its engagement with the bread container-side guide portions 84 when the bread container-side guide portions 84 exists in the vicinity of the upper end portion of the baking chamber 30, and at this stage, the pedestal 83 of the bread container 80 has not reached the bread container support 14. This makes it possible for the user to easily adjust the orientation of the bread container 80 to attach the bread container 80 into the baking chamber 30. Furthermore, the elasticity of the main body-side guide portions 32 allows secure fastening of the bread container 80. Moreover, the fastening function obtained by this fastening method does not vary depending on which direction the blade rotation shaft 82 rotates.

When the bread-making course using rice grains is started, the soaking step starts to be carried out in response to an instruction from the control device 130. In the soaking step, the bread ingredients which have been placed in the bread container 80 beforehand are left stationary, and the ingredients are kept in this state for a predetermined period of time (for thirty minutes in this embodiment). The soaking step aims to make the rice grains absorb water to thereby make the rice grains easy to be ground to the core in the grinding step which is performed after the soaking step.

Note that the speed at which the rice grains absorb water varies depending on the water temperature such that the rice grains absorb water fast when the water temperature is high while they absorb water slowly when the water temperature is low. Thus, the soaking step may be carried out for various lengths of time depending on, for example, the temperature of the environment in which the automatic bread machine 1 is used. This makes it possible to reduce variation in extent to which the rice grains absorb water. Furthermore, for shorter soaking time, the sheath heater 31 may be energized to raise the temperature in the baking chamber 30.

Moreover, the grinding blade 92 may be made to rotate in the starting stage of the soaking step, and further, thereafter, the grinding blade 92 may also be made to rotate intermittently. In this way, it is possible to scratch surfaces of the rice grains, to thereby make the rice grains absorb liquid at a higher efficiency.

When the above-mentioned predetermined period of time elapses, in response to an instruction from the control device 130, the soaking step finishes and the grinding step starts to be carried out to crush the rice grains. In the grinding step, the grinding blade 92 is made to rotate at a high speed (for example, 7000 to 8000 rpm) in a mixture containing the rice grains and the water. In the grinding step, the control device 130 controls the grinding motor 60 to make the blade rotation shaft 82 rotate reversely (in the clockwise direction in FIGS. 12A and 12B, and in the counterclockwise direction in FIGS. 13A and 13B). When the blade rotation shaft 82 rotates reversely, the grinding blade 92 rotates with its cutting edge at the front in the rotation direction, and thus the grinding blade 92 exerts a grinding function.

It should be noted that, in a case in which the grinding motor 60 is used to make the grinding blade 92 rotate, the control device 130 drives the clutch solenoid 73 to make the clutch 56 intercept force (to achieve the state illustrated in FIG. 3A). This is because, as described above, the motor could be damaged without such a control.

In the case in which the blade rotation shaft 82 is reversely rotated to rotate the grinding blade 92, the dome-shaped cover 93 also starts to rotate following the rotation of the blade rotation shaft 82, but the rotation of the dome-shaped cover 93 is soon blocked (stopped) by the following operation. Here, preferably, the grinding blade 92 is made to rotate at a low speed in the starting stage of the grinding step and thereafter, made to rotate at a high speed.

The direction in which the dome-shaped cover 93 rotates along with the rotation of the blade rotation shaft 82 which makes the grinding blade 92 rotate is the counterclockwise direction in FIGS. 13A and 13B, and the mixing/kneading blade 101, if it has been in the folded position (the position illustrated in FIG. 13A), changes its position toward the open position (the position illustrated in FIG. 13B) by receiving resistance from the mixture containing the rice grains and the water.

As the mixing/kneading blade 101 moves into the open position, the first engagement portion 103bb of the second engagement body 103b retracts from the rotation path of the engagement portions 103ab of the first engagement body 103a. Thereby, the cover clutch 103 disconnects the blade rotation shaft 82 and the dome-shaped cover 93 from each other. As shown in FIG. 13B, a portion of the mixing/kneading blade 101 (specifically, the cushioning member 107 provided at an edge side of the mixing-kneading blade 101), after moving into the open position, comes in contact with an internal side wall of the bread container 80 (specifically, a ridge shaped projection 80b provided on the internal side wall of the bread container 80 to improve the efficiency of grinding). Thereby, the rotation of the dome-shaped cover 93 is blocked (stopped).

Vibration arises in the grinding step while the grinding blade 92 is rotating, but the adoption of the configuration in which the cushioning member 107 is in contact with the bread container 80, collision noise caused by the vibration is reduced.

The grinding operation of the rice grains in the grinding step is carried out with respect to the rice grains which have absorbed water in the preceding soaking step, and thus the rice grains can be easily ground to the core. The rotation of the grinding blade 92 in the grinding step is an intermittent rotation. The intermittent rotation is carried out in a cycle in which, for example, the grinding blade 92 rotates for 30 seconds and then stops for five minutes, and this cycle is repeated 10 times. The five-minute stop is omitted in the last cycle. The grinding blade 92 may rotate continuously, in view of, for example, preventing the temperature of the ingredients placed inside the bread container 80 from rising too high, intermittent rotation is preferable.

In the grinding step, since the grinding of the rice grains is carried out inside the dome-shaped cover 93 which has stopped its rotation, possibility of the rice grains scattering out of the bread container 80 is low. Furthermore, the rice grains, entering the dome-shaped cover 93 through the openings 106d of the guard 106 which is not rotating, is sheared between the stationary spokes 106c and the rotating grinding blade 92, and this contributes to efficient grinding. Moreover, the ribs 93e provided in the dome-shaped cover 93 help reduce the flow (in the same direction as the rotation direction of the grinding blade 92) of the mixture containing the rice grains and the water, and this contributes to efficient grinding.

Part of the mixture now containing the ground rice grains and the water is directed by the ribs 93e of the dome-shaped cover 93 toward the windows 93d, and the mixture is discharged through the windows 93d to outside of the dome-shaped cover 93. Each of the ribs 93e of the dome-shaped cover 93 is curved such that a side thereof that faces the mixture when the mixture rushes thereto is convex, the mixture is not likely to stay on the surfaces of the ribs 93e, and thus smoothly flows toward the windows 93d. Another part of the mixture existing in the space above the recess 81, taking place of the part of the mixture which is discharged from inside of the dome-shaped cover 93, enters the recess 81, and then flows from the recess 81 through the openings 106b of the guard 106 into the dome-shaped cover 93. Since the grinding of the rice grains by the grinding blade is carried out with this circulation, it is possible to grind the rice grains efficiently.

Here, in the automatic bread machine 1, the grinding step is set to finish in a predetermined period of time (50 minutes in the present embodiment). However, in some cases, there may be variation in fineness of flour obtained by the grinding depending on factors such as variation in hardness of rice grains and environmental conditions. To deal with such cases, when to finish the grinding step may be determined based on, for example, magnitude of a load on the grinding motor 60 (which can be determined from a control current of the motor) as an indicator. Besides, the provision of the gasket 113 makes it difficult for steam generated in the grinding step to enter the bread ingredient dispenser 110.

When the grinding step finishes, the resting step starts to be carried out in response to an instruction from the control device 130. The resting step is provided as a cooling time for cooling down the stuff inside the bread container 80 whose temperature has been raised in the grinding step. The cooling down is necessary for the following mixing/kneading step to be carried out at a temperature (for example, around 30° C.) at which yeast actively works. In the present embodiment, a time period for the resting step is set to a predetermined time (30 minutes), but the resting step may continue until the temperature of the bread container, for example, falls to a predetermined temperature.

When the resting step finishes, the mixing/kneading step starts to be carried out in response to an instruction from the control device 130. To start the mixing/kneading step, the control device 130 drives the clutch solenoid 73 to make the clutch 56 perform force transmission (the state illustrated in FIG. 3B). Then the control device 130 controls the mixing/kneading motor 50 to make the blade rotation shaft 82 rotate in the forward direction (in the counterclockwise direction in FIGS. 12A and 12B, in the clockwise direction in FIGS. 13A and 13B).

If the blade rotation shaft 82 rotates forward, the grinding blade 92 also rotates in the forward direction. In this case, the grinding blade 92 rotates with its cutting edge at the back in the rotation direction, and thus does not exert the grinding function. The rotation of the grinding blade 92 makes part of the bread ingredients existing around the grinding blade 92 flow in the forward direction. The dome-shaped cover 93 is caused by this flow of the bread ingredients to move in the forward direction (in the clockwise direction in FIGS. 13A and 13B), and then, receiving resistance from stationary part of the bread ingredients, the mixing/kneading blade 101 changes its angle so that the position thereof changes from the open position (see FIG. 13B) to the folded position (see FIG. 13A). Along with this, the engagement portion 103bb of the second engagement body 103b comes to be positioned at an angle at which it interferes with the rotation path of the engagement portions 103ab of the first engagement body 103a. As a result, the cover clutch 103 connects the blade rotation shaft 82 and the dome-shaped cover 93 with each other, such that the dome-shaped cover 93 is ready to be fully driven by the blade rotation shaft 82. The dome-shaped cover 93 and the mixing/kneading blade 101 in the folded position rotate in the forward direction together with the blade rotation shaft 82.

Note that, for secure achievement of the connection of the above-described connection of the cover clutch 103, it is preferable to make the blade rotation shaft 82 rotate intermittently or slowly in the starting stage of the mixing/kneading step.

When the mixing/kneading blade 101 is in the folded position as described above, the supplementary mixing/kneading blade 102 is aligned on an extension of the mixing/kneading blade 101, and in this state, the supplementary mixing/kneading blade 102 and the mixing/kneading blade 101 together work like an enlarged mixing/kneading blade 101 to press the bread ingredients strongly, contributing to sufficient kneading of dough.

The rotation of the mixing/kneading blade 101 (this term will be used hereinafter as an expression which includes the supplementary mixing/kneading blade 102 in the folded position) is controlled by the control device 130 such that the rotation is very slow in the starting stage of the mixing/kneading step, and is then gradually made faster. In the starting stage of the mixing/kneading step in which the mixing/kneading blade 101 rotates very slowly, the control device 130 drives the automatic supply solenoid 16 to unlock the lid of the bread ingredient dispenser 110. Thus, as shown in FIG. 1B, the lid of the bread ingredient dispenser 110 is opened, and bread ingredients such as gluten and dried yeast are automatically supplied into the bread container 80.

As described above, the bread ingredient dispenser 110 is designed to make it difficult for bread ingredients to stay therein, and thus the automatic supply of bread ingredients can be completed with hardly any of the bread ingredients remaining in the bread ingredient dispenser 110. The automatic bread machine 1 is configured such that, when the lid 40 is in the closed state, the viewing window 41 is located at the front surface side and the bread ingredient dispenser 110 is located at the rear surface side, and besides, the dispenser lid 112 of the bread ingredient dispenser 110 rotates toward the rear surface side, into a state in which a plate-like surface of the dispenser lid 112 is substantially parallel to the vertical direction (the state illustrated in FIG. 19). With this configuration, easy observation of the inside of the bread container 80 is possible by using the viewing window 41 even after the automatic supply performed by using the bread ingredient dispenser 110.

In the present embodiment, the automatic supply of the bread ingredients held in the bread ingredient dispenser 110 is carried out with the mixing/kneading blade 101 rotating. This, however, is not meant as a limitation, and the automatic supply of the bread ingredients held in the bread ingredient dispenser 110 may be carried out while the mixing/kneading blade 101 is stationary. Note, however, that it is more preferable to carry out the automatic supply of the bread ingredients with the mixing/kneading blade 101 rotating as in the present embodiment, in which manner the bread ingredients are able to be uniformly scattered.

After the bread ingredients held in the bread ingredient dispenser 110 are dispensed into the bread container 80, all the bread ingredients are mixed and kneaded by the rotation of the mixing/kneading blade 101 into a mass of dough having predetermined elasticity. The mixing/kneading blade 101 swings the dough around and beats it against the internal wall of the bread container 80, and this adds a “pressing” element to the mixing/kneading. The dome-shaped cover 93 also rotates along with the rotation of the mixing/kneading blade 101. When the dome-shaped cover 93 rotates, the ribs 93e of the dome-shaped cover 93 also rotates, and thus, part of the bread ingredients existing in the dome-shaped cover 93 is quickly discharged through the windows 93d, to be mixed with the mass of dough that is being mixed and kneaded by the mixing/kneading blade 101.

In the mixing/kneading step, along with the dome-shaped cover 93, the guard 106 also rotates in the forward direction. Each of the spokes 106c of the guard 106 is arranged such that a portion thereof close to a center of the guard 106 rotates ahead of a portion thereof close to a periphery of the guard 106 in the forward rotation. With this configuration, as the guard 106 rotates in the forward direction, it pushes outward the bread ingredients (the bread dough) existing inside and outside of the dome-shaped cover 93 with the spokes 106c. This helps reduce a ratio of ingredients discarded after bread is baked.

In each of the pillars 106e of the guard 106, the side surface 106eb, which becomes a front surface in the rotation direction when the guard 106 rotates in the forward direction, is tilted obliquely upward. With this configuration, in the mixing/kneading operation, part of the bread ingredients (bread dough) existing around the dome-shaped cover 93 is tossed by the side surface 106eb of each of the pillars 106e. The tossed part of the bread ingredients is mixed into the above mass of the bread ingredients (dough), which helps reduce the ratio of ingredients discarded after bread is baked.

In the automatic bread machine 1, an experimentally obtained predetermined time period (10 minutes in the present embodiment) is adopted as a time period for the mixing/kneading step. In some cases, however, if the time period for the mixing/kneading step is set constant, the condition of the bread dough when it's finished may vary depending on, for example, the temperature of the environment in which the automatic bread machine 1 is used. To deal with such cases, when to finish the mixing/kneading step may be determined based on, for example, magnitude of a load on the mixing/kneading motor 50 (which can be determined from a control current of the motor, for example) as an indicator.

In cases of making bread containing special ingredients (such as raisins, nuts, and cheese), such ingredients are supplied in the course of the mixing/kneading step.

When the mixing/kneading step is finished, the fermentation step starts to be carried out in response to an instruction from the control device 130. In the fermentation step, the control device 130 controls the sheath heater 31 to keep the temperature in the baking chamber 30 at a level (for example 38° C.) that is suitable for fermentation. Then the bread dough is left in an environment that is suitable for fermentation for a predetermined period of time (for 60 minutes in the present embodiment).

If necessary, the mixing/kneading blade 101 may be rotated in the course of the fermentation step to deflate or round the dough.

When the fermentation step is finished, the baking step starts to be carried out in response to an instruction from the control device 130. The control device 130 controls the sheath heater 31 to raise the temperature in the baking chamber 30 up to a level (for example 125° C.) suitable for baking bread. Then, the control device 130 carries out control such that bread is baked for a predetermined period of time (50 minutes in the present embodiment) in a baking environment. When the baking step is finished, it is informed to the user through, for example, a display on a liquid crystal display panel of the operation portion 20 and/or a notification sound. Noticing that the bread-making course is finished, the user opens the lid 40 to take out the bread container 80, to thereby complete the breadmaking operation.

The bread can be taken out of the bread container 80 by pointing the opening of the bread container 80 obliquely downward. Together with the bread, the blade unit 90 attached to the blade rotation shaft 82 is also taken out of the bread container 80. The presence of the guard 106 helps prevent the user from touching the grinding blade 92 in taking out the bread, and thus the user is able to carry out the operation safely. In a bottom of the bread, there are left marks of the mixing/kneading blade 101 and the supplementary mixing/kneading blade 102 (projecting upward from the recess 81 of the bread container 80) of the blade unit 90. However, since the dome-shaped cover 93 and the guard 106 are disposed in the recess 81, their marks left in the bottom of the bread are not too large.

In a case in which commercially available cereal flour such as wheat flour or rice flour, instead of cereal grains such as rice grains, is used as a starting ingredient to make bread, the bread container 140 is set in the baking chamber 30. The unillustrated mixing/kneading blade is attached to the blade rotation shaft 142, cereal flour, water, and the other bread ingredients are placed in the bread container 140, and the mixing (kneading) step, the fermentation step, and the baking step are carried out one after another as bread-making steps.

(Storage of Automatic Bread Machine)

In putting away the automatic bread machine 1 in its storage place after a breadmaking operation, the bread container 140 is placed inside the bread container 80. At this time, two kinds of cushioning members are interposed between the bread container 80 and the bread container 140 (see FIGS. 24 and 25).

A first cushioning member is a cushioning member 144 which is placed on an internal bottom surface of the bread container 80 to receive an external bottom surface of the bread container 140, that is, the pedestal 143. The cushioning member 144 is a cylindrical block made of foamed polystyrene, and is inserted into the recess 81. The cushioning member 144 keeps the bread container 80 and the bread container 140 spaced from each other by a predetermined distance in a height direction so that they will not come into contact with each other.

At a center of the cushioning member 144, there is provided a through hole 144a for inserting the blade rotation shaft 82 therethrough. At a top surface of the cushioning member 144, there is provided an uneven engagement portion 144b which receives the pedestal 143 of the bread container 140. The uneven engagement portion 144b in the present embodiment is formed as a projection that is circular-shaped in plan view and fits in the pedestal 143, but the uneven engagement portion 144b may be shaped otherwise. For example, the uneven engagement portion 144b may be formed as a recess in which the pedestal 143 fits.

A second cushioning member is a cushioning member 145 which is placed along an internal circumferential surface of the bread container 80. The cushioning member 145 is made by stamping and bending a sheet of corrugated cardboard into a predetermined shape, in which perpendicular wall portions 145b rise at four sides of a base portion 145a which is similar in shape to a horizontal sectional shape of the bread container 80. The four perpendicular wall portions 145b cover an external circumferential surface of the bread container 140 at four sides. Upper ends of the perpendicular wall portions 145b are bent outward, forming hook portions 145c. Ends of the hook portions 145c are placed on the brim portion 80a of the bread container 80, and thereby, the cushioning member 145 is kept to a predetermined height with respect to the bread container 80. In the base portion 145a, there is provided a through hole 145d for inserting therethrough the pedestal 143 of the bread container 140.

By placing the bread container 140 in the bread container 80 as described above, both of the two kinds of bread containers are able to be accommodated in the baking chamber 30 together. This eliminates need of a storage space that is larger than a volume of the main body 10 of the automatic bread machine 1, making it possible to compactly store the automatic bread machine 1. Furthermore, the presence of the cushioning members 144 and 145 placed in the bread container 80 helps prevent the bread container 80 and the bread container 140 from coming into direct contact with each other to be damaged. The cushioning member 144 is provided with the uneven engagement portion 144b which receives the pedestal 143 of the bread container 140, and this helps stabilize the position of the pedestal 143 and prevent the pedestal 143 from horizontally swinging to collide against the bread container 80.

There is no limitation to the material of the cushioning members; it is possible to produce the cushioning members at very low cost by using foamed polystyrene as the material of the cushioning member 144 and corrugated cardboard as the material of the cushioning member 145.

(Others)

The present embodiment is merely an example of the present invention, and the configuration of the automatic bread machine to which the present invention is applied is not limited to the present embodiment.

For example, the main body 10 constituting the automatic bread machine 1 may have the following configuration. During the grinding step of the automatic bread machine 1, large noise tends to be generated in the bread container 80. To cope with such an inconvenience, it is preferable to so configure the main body 10 of the automatic bread machine 1 as to allow minimum leakage of noise generated in the grinding step to outside from the main body 10.

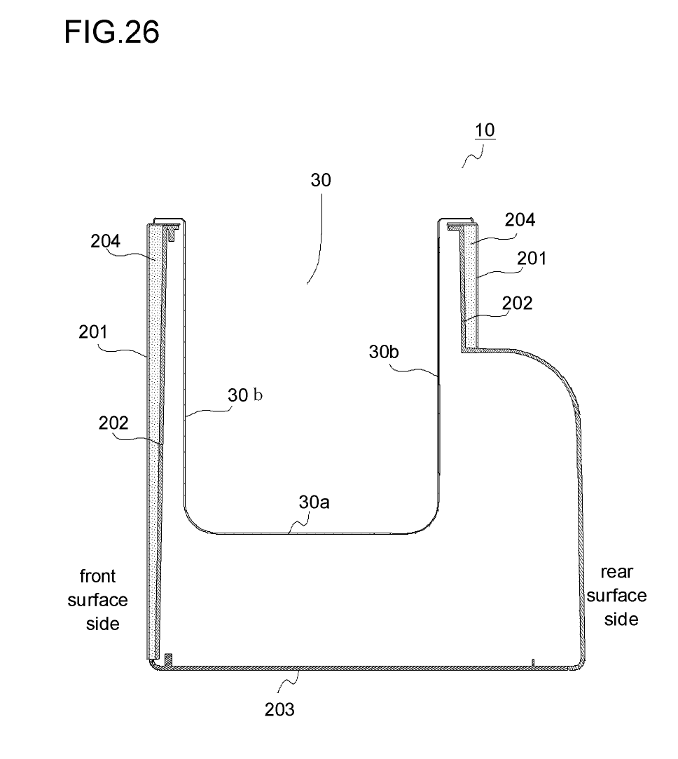

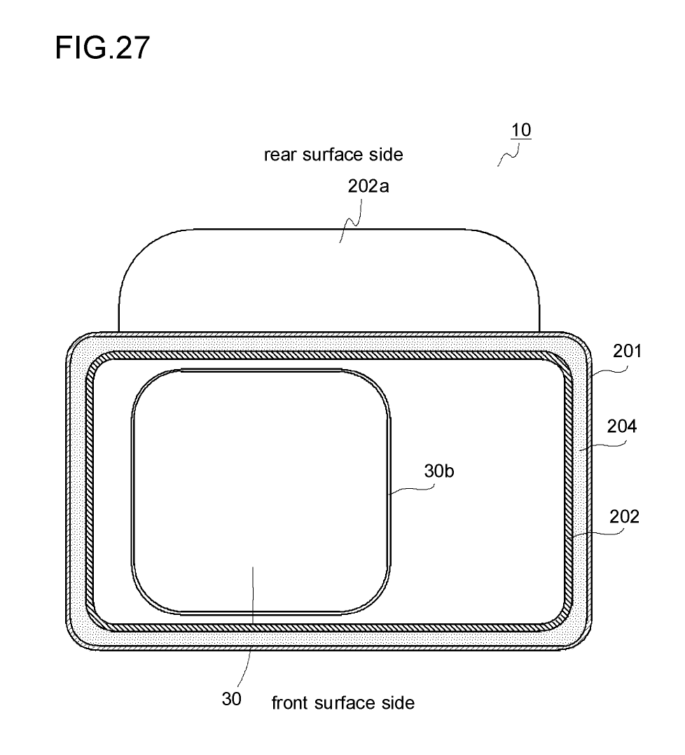

FIG. 26 is a schematic diagram for describing a modified example of the configuration of the main body of the automatic bread machine according to the present embodiment, illustrated as a sectional view obtained by vertically cutting the main body. FIG. 27 is a schematic diagram for describing the modified example of the configuration of the main body of the automatic bread machine according to the present embodiment, illustrated as a sectional view obtained by horizontally cutting the main body. In FIG. 26, the left side is the front surface side, and the right side is the rear surface side. In FIG. 27, the lower side is the front surface side, and the upper side is the rear surface side.

As shown in FIGS. 26 and 27, the main body 10 of the automatic bread machine 1 of the modified example has an outer shell 201 and an inner shell 202. The outer shell 201 is made of a metal such as a stainless steel sheet, and as shown in FIG. 27, so provided as to surround a side wall 30b (arranged substantially rectangular in horizontal section) which defines the baking chamber 30. The outer shell 201 constitutes most part of an external wall of the main body 10.

The inner shell 202 is made of resin, for example, and like the outer shell 201, so provided as to surround the side wall 30b (arranged substantially rectangular in horizontal section) which defines the baking chamber 30 (see FIG. 27). The inner shell 202 is configured such that at the rear surface side of the main body 10, a portion 202a of the inner shell 202 projects outward beyond the outer shell 201 and constitutes the external wall of the main body 10, but most part of the inner shell 202 is arranged inside the outer shell 201. Components such as the mixing/kneading motor 50 and the grinding motor 60 provided in the automatic bread machine 1 are arranged inside the inner shell 202.

Here, a bottom portion 203 of the main body 10 is constituted of a member that is different from the outer shell 201 and the inner shell 202, and thanks to the member constituting the bottom portion 203, inside of the main body 10 is not visible directly from below. The bottom portion 203, however, may be integrally formed with the outer shell 201 or with the inner shell 202.

Furthermore, there is a space provided between the outer shell 201 and the inner shell 202, in which space a sound insulating member 204 is provided. The sound insulating member 204 is provided for the purpose of reducing leakage of large noise generated during the grinding step inside the main body 10 of the automatic bread machine 1 to the outside. The sound insulating member 204 is made of, for example, aluminum silicate.

In the automatic bread machine 1, in the baking step, fermented bread dough is baked at a temperature as high as 100° C. or higher, for example, and thus, if the outer shell 201 of the main body 10 is made of metal, the outer shell 201 tends to become hot. Thus, it is preferable that the sound insulating member 204 disposed in the space between the outer shell 201 and the inner shell 202 be also provided with a heat insulating function in addition to the sound insulating function. In view of this point, aluminum silicate is chosen as the material of the sound insulating member 204.

The sound insulating member 204 which exerts not only the sound insulating function but also the heat insulating function may be made of a material other than aluminum silicate, and thus may be made of, for example, glass wool. Furthermore, if other measures are adopted to prevent the outer shell 201 from becoming hot, the sound insulating member 204 does not need to exert the heat insulating function, and thus, it may be made of, for example, heat resisting rubber. Moreover, the sound insulating member 204 does not necessarily need to be made of a single material, but instead, it may be made as a lamination of a plurality of materials.

As described above, in the automatic bread machine 1 of the modified example, the sound insulating member 204 is arranged to surround the source of large noise generated during the grinding step (the inside of the bread container 80 placed in the baking chamber 30). This makes it possible to reduce leakage of large noise from the automatic bread machine 1 during the grinding step.

In the modified example, as described above, a portion of the inner shell 202 constituting the main body 10 projects beyond the outer shell 201. This, however, is not meant as a limitation, and the inner shell may be arranged completely inside the outer shell.

Furthermore, in the modified example, as described above, the inner shell 202 is provided in addition to the outer shell 201, but this is not meant as a limitation. If it is possible to fasten the sound insulating member 204 to the outer shell 201, the inner shell 202 is not necessary. Moreover, instead of making the outer shell 201 and the inner shell 202 of different materials, they may be made of the same material.

Besides, although, in the modified example, no sound insulating member is arranged at a portion of the rear surface side of the main body 10 or at the bottom portion of the main body 10 as described above, it goes without saying that sound insulating members may be arranged at such portions as well. Moreover, the lid 40 may also be provided with a sound insulating member.

And furthermore, the following modification may be applied to the guide structure which is provided for smooth setting of the bread container 80 in the baking chamber 30. In the above-described embodiments, the projecting-plate portion 322 of each of the main body-side guide portions 32 has the bent portions 322a to 322c (see, for example, FIG. 6A). This, however, does not mean that the present invention is limited to the configuration. That is, the projecting-plate portion 322 may be configured without any bent portions. Besides, in the case in which the projecting-plate portion 322 is provided with the bent portions, the number, for example, of the bent portions may be different from that which is adopted in the present embodiment (for example, providing only the second bent portion 322b).

Furthermore, in the embodiments described above, the main body-side guide portions 32 and the side wall 30b of the baking chamber 30 are separate members, but the main body-side guide portions 32 may be integrally formed with the side wall 30b of the baking chamber 30. Likewise, the bread container-side guide portions 84 may be integrally formed with the bread container 80.

Moreover, in the embodiments described above, the guide portions on the main body have elasticity while those on the bread container do not, but the present invention is not limited to this configuration. That is, for example, a configuration may be adopted in which the main body is provided with guide portions that have elasticity while the bread container is provided with guide portions that do not have elasticity (s configuration opposite to the configuration of the present embodiment). And besides, it is even possible to adopt a configuration in which the guide portions both on the main body and the bread container do not have elasticity.

Furthermore, the following modification may be applied to the configuration of the bread container 80. In the embodiments described above, the carrying handle 85 (an example of a handle member of the present invention), which is provided on the bread container 80 to be able to be raised or laid down freely, is supported by partly being in contact with the brim portion 80a of the bread container 80 when the carrying handle 85 is laid down (see, for example, FIG. 7B). With this configuration, the maim body portion (specifically, the brim portion 80a) of the bread container 80 is prone to damage due to the contact with the carrying handle 85.

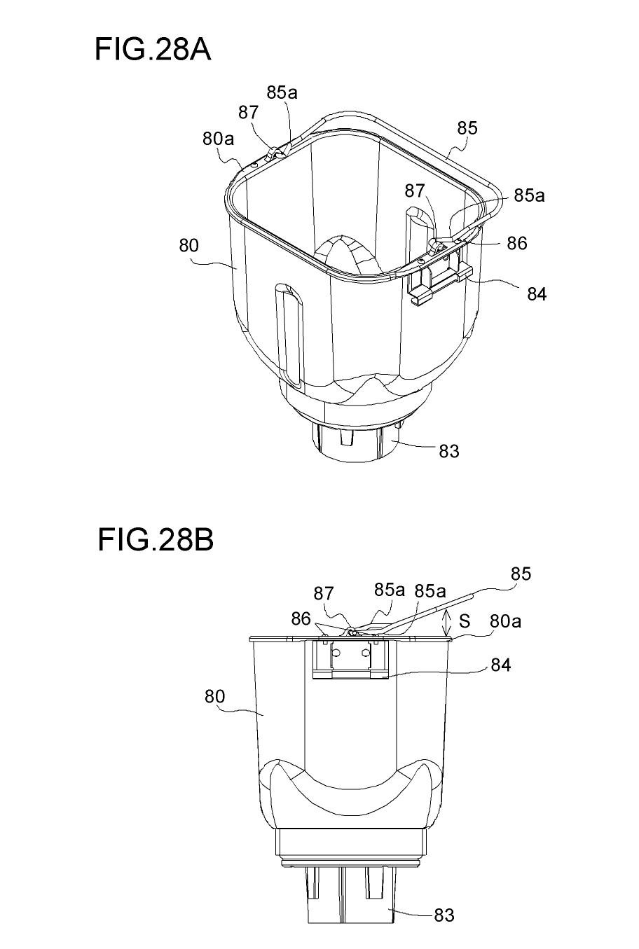

Considering such an inconvenience, it is preferable that the bread container 80 be configured such that, as shown in FIGS. 28A and 28B, a portion of the carrying handle 85 in a laid-down state is in contact with fastening members 86 (for example, rivets or screws) for fastening the bread container-side guide portions 84. Specifically, the carrying handle 85 is partly in contact with portions of the fastening members 89 projecting from the brim portion 80a. This configuration helps prevent the main body portion of the bread container 80 from being damaged.

Here, in the bread container 80 illustrated in FIGS. 28A and 28B, the carrying handle 85 is configured such that there is enough space S between end portions of the carrying handle 85 and the brim portion 80a in whichever direction the carrying handle 85 is laid down from the raised state (the carrying handle 85 can be laid down in both right and left directions in FIG. 28B). The space S allows the user wearing a heat protector such as a kitchen mitten to easily grip the carrying handle 85 to take the bread container 80 out of the bread container 80 after a breadmaking operation is finished.

Specifically, the carrying handle 85 has projections 85a obtained by bending portions thereof that are in the vicinity of support portions 87 (rotatably supporting the carrying handle 85) and that lie along the brim portion 80a when the carrying handle is laid down. The bending in forming the projections 85a is carried out in opposite directions at one and the other ends of the carrying handle 85. And, the bending directions are determined such that space is provided between the end portions of the carrying handle 85 and the brim portion 80a in whichever direction the carrying handle 85 is laid down from the raised state. When the carrying handle 85 is laid down, portions of the carrying handle 85 in the vicinity of the projections 85a are in contact with the fastening members 86, such that the other portions of the carrying handle 85 which has been laid down from the raised state do not collide against the bread container 80.

In the embodiments described above, the bread ingredient dispenser 110 is attached to the lid 40, but the bread ingredient dispenser 110 may be attached to the main body 10.

In the case of making bread by using wheat flour or rice flour as a starting ingredient, it is possible to make bread containing special ingredients such as raisins and nuts by using the bread ingredient dispenser 110 to place such special ingredients therein.

The above-descriptions of embodiments have dealt with rice grains as a typical example of cereal grains used as a starting ingredient, but besides rice grains, grains of other cereals such as wheat, barley, foxtail millet, Japanese barnyard millet, buckwheat, corn, and soy are able to be used as a starting ingredient.

The above-described flow of the bread-making course using rice grains is just an example, and any other flow is possible. For example, the resting step after the grinding step may be omitted.

In the embodiments described above, the grinding blade 92 and the mixing/kneading blade 101 are included in the blade unit 90, and the blade unit 90 is attached to and detached from the blade rotation shaft 82. This configuration, however, is not meant as a limitation, and the grinding blade 92 and the mixing/kneading blade 101 may be separately attached to the blade rotation shaft 82. Even a configuration may be adopted where, for example, a single blade which exerts both the grinding and mixing/kneading functions is provided instead of separately providing the grinding blade and the mixing/kneading blade.

In the embodiments described above, different motors are used for grinding cereal grains by the grinding blade 92 and for mixing/kneading bread ingredients by the mixing/kneading blade 101 into bread dough. However, this does not mean that the automatic bread machine of the present invention is limited to this configuration. That is, for example, with only a single motor, force to grind cereal grains by the grinding blade 92 and force to mix/knead bread dough by the mixing/kneading blade 101 may both be obtained from the same single motor.

In the embodiments described above, automatic bread machines have been dealt with in which a breadmaking process is performed from start to finish, starting with the grinding step, then the mixing/kneading step, then the fermentation step, and finally the baking step; however, the automatic bread machine of the present invention is able to be configured as an apparatus for carrying out steps from the grinding step to the fermentation step, or as an apparatus for carrying out just the grinding step and the mixing/kneading step. In such cases, the baking step, or the fermentation step and the baking step, is or are performed by an external apparatus such as an oven. Furthermore, it is possible to develop the automatic bread machine of the present invention into an apparatus for business use as well.

### INDUSTRIAL APPLICABILITY

The present invention is preferably applicable to automatic bread machines for household use.

### LIST OF REFERENCE SYMBOLS

1 automatic bread machine
10 main body
11a main body-side connection portion (part of coupling)
30 baking chamber (accommodation area)
50 mixing/kneading motor
60 grinding motor
32 main body-side guide portion
80 bread container (first bread container)
80a brim portion of bread container
81 recess
82 blade rotation shaft
82a container-side connection portion (part of coupling)
83 pedestal
84 bread container-side guide portion
85 handle (handle member)
86 fastening member
92 grinding blade
101 mixing/kneading blade
140 bread container (second bread container)
144 cushioning member (first cushioning member)
145 cushioning member (second cushioning member)
321 fastened portion
322 projecting-plate portion (engagement projection portion)
322b second bent portion
841 engagement groove
CP coupling

1. An automatic bread machine, comprising:
a first bread container which allows breadmaking by using cereal grains as a starting ingredient;
a second bread container which allows breadmaking by using cereal flour as a starting ingredient; and
an accommodation area in which one of the first bread container and the second bread container is selectively placed for breadmaking, and which accommodates both of the first bread container and the second bread container for storage purpose in a state in which one of the first bread container and the second bread container is placed inside another.

2. The automatic bread machine according to claim 1,
wherein,
when one of the first bread container and the second bread container is stored inside another, a first cushioning member is disposed on an internal bottom surface of an outside bread container to receive an external bottom surface of an inside bread container, and a second cushioning member is disposed along an internal circumferential surface of the outside container to cover an external circumferential surface of the inside bread container.

3. The automatic bread machine according to claim 2,
wherein
the outside bread container is the first bread container which has a bottom portion with a recess formed therein; and
when the inside container is stored in the outside container, the first cushioning member is placed in the recess.

4. The automatic bread machine according to claim 2,
wherein
the first cushioning member is made of foamed polystyrene and the second cushioning member is made of corrugated cardboard.

5. The automatic bread machine according to claim 1,
wherein
an external side surface of the first bread container is provided with a bread container-side guide portion; and
an internal side surface of the accommodation area is provided with a main body-side guide portion which engage with the bread container-side guide portion in vicinity of an upper end portion of the accommodation area to guide the first bread container to a setting position thereof in the accommodation area.

6. The automatic bread machine according to claim 5,
wherein
a pedestal is provided on an external surface side of a bottom portion of the first bread container;
a bread container support portion which receives the pedestal is provided at a bottom portion of the accommodation area; and
the main body-side guide portion is provided in such a manner that the pedestal has not reached the bread container support portion yet at a time when the bread container-side guide portion and the main body-side guide portion start engaging with each other.

7. The automatic bread machine according to claim 5,
wherein,
in a state in which the first bread container is disposed in the setting position, the bread container-side guide portion and the main body-side guide portion cooperate with each other to exert a function of fastening the first bread container.

8. The automatic bread machine according to claim 5, further comprising:
a rotation shaft which is provided at a bottom portion of the first bread container;
a grinding blade and a mixing/kneading blade which are rotatable by rotation of the rotation shaft;
a motor which is provided inside a main body which has the accommodation area; and
a coupling which transmits rotation force of the motor to the rotation shaft of the first bread container placed in the accommodation area,
wherein
the grinding blade exerts a grinding function when the rotation shaft is made to rotate in one direction by the motor, and the mixing/kneading blade exerts a mixing/kneading function when the rotation shaft is made to rotate in a direction reverse to said one direction.

9. The automatic bread machine according to claim 5,
wherein
a brim portion is provided along an edge of an opening of the first bread container;
a carrying handle is attached to the brim portion in such a manner that the carrying handle is able to be raised/laid down freely; and
in a state in which the carrying handle is laid down, a portion of the carrying handle is in contact with a projecting portion of a fastening member projecting from the brim portion, the fastening member being provided for fastening the bread container-side guide portion.

10. The automatic bread machine according to claim 5,
wherein
the bread container-side guide portion has an engagement groove which extends in a direction in which the first bread container is moved to be received in the accommodation area, and the main body-side guide portion has an engagement projection portion which projects from an internal side surface of the accommodation area and engages with the engagement groove.

11. The automatic bread machine according to claim 10,
wherein
the main body-side guide portion has a plate-shaped fastened portion which is attached to the internal side surface of the accommodation area and a projecting-plate portion which is bent over the fastened portion, the projecting-plate portion being the engagement projection portion.

12. The automatic bread machine according to claim 11,
wherein
the projecting-plate portion has a bent portion at which a slope angle of the projecting-plate portion is increased with respect to the fastened portion.

13. The automatic bread machine according to claim 10,
wherein
the engagement groove extends to vicinity of an upper end portion of the first bread container.
